(19) United States
(12) Patent Application Publication
(10) Pub. No.: US 2020/0285551 A1
(43) Pub. Date: Sep. 10, 2020

(54) STORAGE SYSTEM, DATA MANAGEMENT METHOD, AND DATA MANAGEMENT PROGRAM

(71) Applicant: HITACHI, LTD., Tokyo (JP)

(72) Inventors: Hiroki FUJII, Tokyo (JP); Yoshinori OHIRA, Tokyo (JP)

(73) Assignee: HITACHI, LTD., Tokyo (JP)

(21) Appl. No.: 16/558,561

(22) Filed: Sep. 3, 2019

(30) Foreign Application Priority Data
Mar. 4, 2019 (JP) 2019-038790

(51) Int. Cl. G06F 11/20; G06F 11/10

(52) U.S. Cl. CPC G06F 11/2094; G06F 2201/82; G06F 11/1092

(57) ABSTRACT

In an upper storage device, a BEPK and an MP are provided, each of a plurality of lower storage devices has a plurality of stripes configuring a plurality of stripe rows, each of the plurality of stripe rows is a row of two or more stripes which the plurality of lower storage devices have, respectively, when each of the plurality of stripe rows stores a plurality of data elements and a redundant code and a predetermined allowable number of lower storage devices fail, the data elements in the stripes can be restored and the MP controls a processing speed in restoration processing, on the basis of restoration priorities for the data elements or the redundant code of failed stripes in the failed lower storage devices.

### BACKGROUND OF THE INVENTION

### 1. Field of the Invention

The present invention relates to a storage system or the like that configures a redundant array of Independent Disks (RAID) group by a plurality of storage devices, and relates to technology for managing data.

### 2. Description of the Related Art

Conventionally, a RAID group is configured by a plurality of storage devices in a storage system, and a logical volume created on the basis of the RAID group is provided to a host device (for example, a host computer).

In the storage system, when a failure occurs in any storage devices configuring the RAID group storing redundant data, the redundant data or the like is used to restore (rebuild) data stored in the storage device in which the failure has occurred.

As technology relating to RAID, JP 2015-525377 W discloses technology for detecting, from a plurality of stripe rows including normal data and redundant data to restore the normal data, stripe rows in which storage devices of a predetermined allowable number or a number closest to the predetermined allowable number among a plurality of storage devices storing stripe data elements of the stripe rows fail, giving priority to the stripe data elements of the detected stripe rows, and restoring the stripe rows in the storage devices.

### SUMMARY OF THE INVENTION

In a storage system that manages data used by a host (host computer), generally, it may be necessary to continuously perform processing by the host. In the storage system, when a failure occurs in the storage device, it is necessary to rebuild data stored in the storage device in which the failure has occurred, in a state in which I/O processing by the host is continuously performed. In this case, in the storage system, it is necessary to process I/O from the host and to process I/O relating to rebuilding. For this reason, I/O performance (host I/O performance) to the host may be degraded during the rebuilding processing.

In recent years, a capacity of the storage device increases, and a time required for rebuilding increases. In order to speed up rebuilding, it is considered that I/O resources allocated to rebuilding are increased to speed up rebuilding. However, in this case, since the I/O resources allocated to host I/O decrease, a reduction rate of host I/O performance increases. The reduction of the rebuilding time and the reduction of degradation of the I/O performance are in a trade-off relation, and it is difficult to achieve both.

The present invention has been made in view of the above circumstances and an object thereof is to provide technology capable of suppressing degradation of other I/O performance due to rebuilding processing while realizing early securing of data reliability.

In order to achieve the above object, a storage system according to an aspect has an interface that is connected to a plurality of storage devices, and a control unit that is connected to the interface. Each of the plurality of storage devices has a plurality of stripes configuring a plurality of stripe rows. Each of the plurality of stripe rows is a row of two or more stripes which two or more storage devices have, respectively. When each of the plurality of stripe rows stores a plurality of data elements and at least one redundant code and a predetermined allowable number of storage devices fail, the data elements in the stripes of the failed storage devices can be restored. The number of storage devices is more than the number of stripes configuring one stripe row. The control unit controls a processing speed in restoration processing of failed stripes to be the stripes in the failed storage devices, on the basis of restoration priorities for the data elements or the redundant code of the failed stripes.

According to the present invention, it is possible to suppress degradation of other I/O performance due to rebuilding processing while realizing early securing of data reliability.

### BRIEF DESCRIPTION OF THE DRAWINGS

FIG. 1 is a hardware configuration diagram of a computer system according to a first embodiment;

FIG. 2 is a logical configuration diagram of data according to the first embodiment;

FIG. 3 is a logical configuration diagram of data in a lower storage device according to the first embodiment;

FIG. 4 is a diagram showing a table of a shared memory according to the first embodiment;

FIG. 5 is a diagram showing an example of a page mapping table according to the first embodiment;

FIG. 6 is a diagram showing an example of a parcel mapping table according to the first embodiment;

FIG. 7 is a diagram showing an example of a drive state table according to the first embodiment;

FIG. 8 is a configuration diagram of a local memory according to the first embodiment;

FIG. 9 is a flowchart showing speed control rebuilding processing according to the first embodiment;

FIG. 10 is a flowchart showing extent classification processing according to the first embodiment;

FIG. 11 is a flowchart showing an example of rebuilding processing according to the first embodiment;

FIG. 12 is a flowchart showing an example of data restoration processing according to the first embodiment;

FIG. 13 is a flowchart showing an example of normal rebuilding processing according to the first embodiment;

FIG. 14 is a diagram showing an example of a management screen of a management server according to the first embodiment;

FIG. 15 is a flowchart showing an example of speed control rebuilding processing according to a second embodiment;

FIG. 16 is a diagram showing an example of a parcel mapping table according to a third embodiment;

FIG. 17 is a flowchart showing an example of speed control rebuilding processing according to the third embodiment;

FIG. 18 is a flowchart showing an example of data part rebuilding processing according to the third embodiment;

FIG. 19 is a flowchart showing an example of parity part rebuilding processing according to the third embodiment;

FIG. 20 is a configuration diagram of a local memory according to a fourth embodiment;

FIG. 21 is a diagram showing an example of a parcel mapping table according to a fourth embodiment;

FIG. 22 is a flowchart showing an example of speed control rebuilding processing according to the fourth embodiment;

FIG. 23 is a flowchart showing an example of rebuilding destination area determination processing according to the fourth embodiment;

FIG. 24 is a flowchart showing an example of partial data restoration processing according to the fourth embodiment; and

FIG. 25 is a hardware configuration diagram of a computer system according to a fifth embodiment.

### DESCRIPTION OF THE PREFERRED EMBODIMENTS

Several embodiments will be described with reference to the drawings. It is to be noted that the embodiments described below do not limit inventions according to claims and all elements described in the embodiments and combinations thereof are not essential for the solving means of the invention.

Further, in the following description, various information may be described by an expression of an “aaa table”, but the various information may be expressed by any data structure other than the table. To indicate that the information does not depend on the data structure, the “aaa table” can be called “aaa information”.

Further, in the following description, processing may be described with a “program” as the operation subject. However, the program is executed by a processor (for example, a central processing unit (CPU)) and determined processing is performed using storage resources (for example, a memory) and/or a communication interface device (for example, a port) appropriately, so that the subject of the processing may be the processor. The processing described with the “program” as the subject may be processing performed by a processor or a computer (for example, a management computer, a host computer, a storage device, or the like) having the processor. Further, the controller may be the processor, or may include a hardware circuit that performs a part or all of the processing performed by the controller. The program may be installed on each controller from a program source. The program source may be, for example, a program distribution server or a storage medium.

### First Embodiment

An outline of a computer system including a storage system according to a first embodiment will be described.

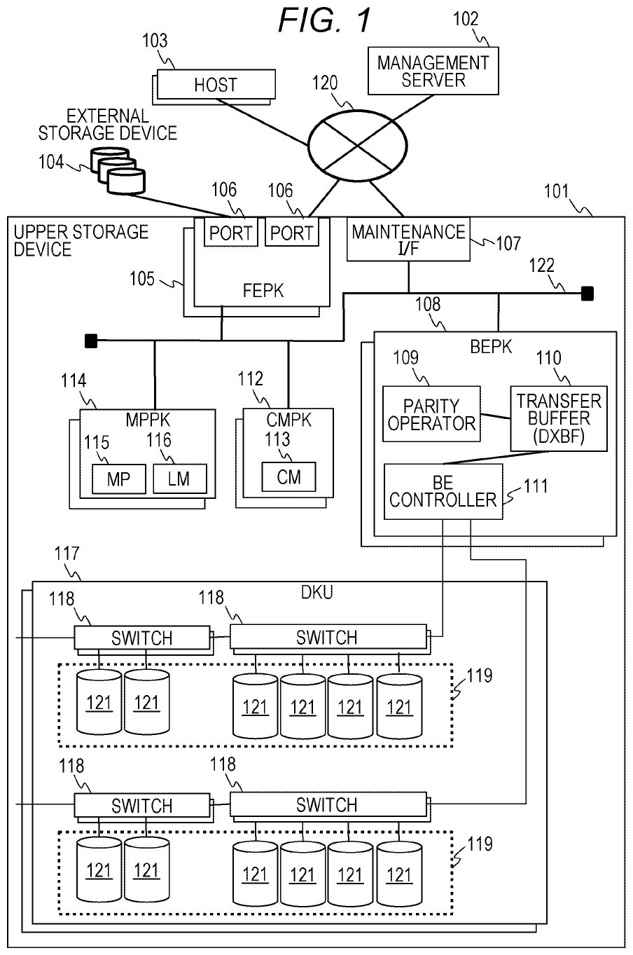

The storage system is configured by using an upper storage device 101 shown in FIG. 1, for example. The storage system may include an external storage device 104. A DKU 117 of the upper storage device 101 is provided with a plurality of lower storage devices 121. In the upper storage device 101, a capacity pool (hereinafter, referred to as a pool) configured by using storage areas of the plurality of lower storage devices 121 is managed. Further, in the upper storage device 101, a RAID group is configured by using the area of the pool. That is, the RAID group is configured by using the plurality of lower storage devices 121 configuring the area of the pool.

The storage area of the RAID group is configured by using a plurality of sub-storage area rows. The respective sub-storage area rows span a plurality of storage devices (the lower storage devices 121 and/or the external storage device 104) configuring the RAID group, and are configured by using the plurality of sub-storage areas corresponding to the plurality of storage devices. Here, one sub-storage area is referred to as a “stripe”, and a row configured by using a plurality of stripes is referred to as a “stripe row”. The storage area of the RAID group is configured by using the plurality of stripe rows.

In the RAID, there are several levels (hereinafter, referred to as “RAID levels”).

For example, in RAID 5, write target data designated by a host computer (referred to as a host) corresponding to the RAID 5 is divided into data of a predetermined size (hereinafter, referred to as a “data unit” for convenience), each data unit is divided into a plurality of data elements (data parts), and the plurality of data elements are written to a plurality of stripes. Further, in the RAID 5, in order to rebuild data elements that cannot be read from a storage device due to a failure occurring in the storage device, redundant information (hereinafter, referred to as a “redundant code” and a “parity part”) called “parity” is generated for each data unit, and the redundant code is also written to a stripe of the same stripe row. For example, when the number of storage devices configuring a RAID group is 4, three data elements configuring the data unit are written to three stripes corresponding to three of the storage devices, and a redundant code is written to a stripe corresponding to the remaining one storage device. Hereinafter, when the data element and the redundant code are not distinguished from each other, both may be referred to as stripe data elements.

Further, in RAID 6, when two data elements among a plurality of data elements configuring a data unit cannot be read due to a failure occurring in two storage devices among a plurality of storage devices configuring the RAID group, in order to be able to restore these two data elements, two types of redundant codes (referred to as P parity and Q parity) are generated for each data unit, and each redundant code is written to a stripe of the same stripe row.

Further, there are RAID levels other than those described above (for example, RAID 1 to RAID 4). Further, as data redundancy technology, there are triple mirroring (Triplication), triple parity technology using three parity, and the like. Further, as a redundant code generation technology, there are various technologies such as Reed-Solomon codes using a Galois field operation and EVEN-ODD. In embodiments of the present invention, the RAID 5 and the RAID 6 will be mainly described. However, the present invention is not limited thereto, and can be applied by replacement of the methods described above.

First, the computer system including the storage system according to the first embodiment will be described.

FIG. 1 is a hardware configuration diagram of the computer system according to the first embodiment.

The computer system includes one or more host computers (hereinafter, referred to as hosts) 103, a management server 102, and an upper storage device 101. The host computer 103, the management server 102, and the upper storage device 101 are connected via a network 120. The network 120 may be a local area network or a wide area network. Further, one or more external storage devices 104 may be connected to the upper storage device 101. The external storage device 104 includes one or more storage devices. The storage device is a non-volatile storage medium, and is, for example, a magnetic disk, a flash memory, or other semiconductor memory.

The host 103 is, for example, a computer executing an application, reads data to be used for the application from the upper storage device 101, and writes data created by the application to the upper storage device 101.

The management server 102 is a computer used by an administrator to execute management processing for managing the computer system. The management server 102 receives a setting of a mode of rebuilding processing to be executed when data is restored according to an operation of the administrator on an input device, and sets the upper storage device 101 to execute the received rebuilding processing.

The upper storage device 101 has one or more front end packages (FEPK) 105, a maintenance interface (maintenance I/F) 107, one or more microprocessor packages (MPPK) 114, one or more cache memory packages (CMPK) 112, one or more back end packages (BEPK) 108, an internal network 122, and one or more disk units (DKU) 117. The FEPK 105, the maintenance I/F 107, the MPPK 114, the CMPK 112, and the BEPK 108 are connected via the internal network 122. The BEPK 108 is connected to the DKU 117 via a plurality of system paths.

The FEPK 105 is an example of an interface device, and has one or more ports 106. The port 106 connects the upper storage device 101 to various devices (the host 103, the external storage device 104, and the like) via the network 120 or the like. The maintenance I/F 107 is an interface for connecting the upper storage device 101 to the management server 102.

The MPPK 114 has a microprocessor (MP) 115 functioning as an example of a control unit and a local memory (LM) 116. The LM 116 stores various programs and various information. The MP 115 executes programs stored in the LM 116 and executes various processing. The MP 115 transmits various commands to the lower storage device 121 of the DKU 117 via the BEPK 108. Further, the MP 115 transmits the various commands to the external storage device 104 via the FEPK 105.

The CMPK 112 has a cache memory (CM) 113. The CM 113 temporarily stores data (write data) to be written from the host 103 to the lower storage device 121 or the like and data (read data) read from the lower storage device 121.

The BEPK 108 is an example of an interface device (interface), and has a parity operator 109, a transfer buffer (DXBF) 110, and a back end controller (BE controller) 111.

The parity operator 109 is, for example, a small processor, and generates a redundant code (hereinafter, referred to as parity) for restoring data elements that cannot be read due to a failure when the failure occurs in the lower storage device 121. For example, with respect to a data unit of a RAID group configured by the RAID 5, the parity operator 109 generates P parity by calculating exclusive OR of a plurality of data elements configuring the data unit. Further, with respect to a data unit of a RAID group configured by the RAID 6, the parity operator 109 generates Q parity by multiplying a plurality of data elements configuring the data unit by a predetermined coefficient and calculating exclusive OR of each data. Further, the parity operator 109 performs restoration processing for restoring any data element in the data unit, on the basis of one or more stripe data elements (data element and/or parity) for the data unit. Further, the parity operator 109 generates a partial operation result by performing a partial operation corresponding to a part of an operation of the restoration processing for restoring any data element, on the basis of one or more stripe data elements for the data unit.

The transfer buffer 110 temporarily stores data transmitted from the lower storage device 121 and data to be transmitted to the lower storage device 121. The BE controller 111 communicates various commands, write data, read data, and the like with the lower storage device 121 of the DKU 117.

The DKU 117 has a plurality of lower storage devices 121 (hereinafter, they may be referred to as drives). The lower storage device 121 includes one or more storage devices. The storage device is a non-volatile storage medium, and is, for example, a magnetic disk, a flash memory, or other semiconductor memory. The DKU 117 has a plurality of groups (path groups) 119 of the plurality of lower storage devices 121 connected by the same path as the BE controller 111. The lower storage devices 121 belonging to the same path group 119 are connected via a switch 118. The lower storage devices 121 belonging to the same path group 119 can directly communicate with each other. For example, various data can be transmitted from one lower storage device 121 belonging to the same path group 119 to another lower storage device 121. The lower storage devices 121 belonging to the different path groups 119 cannot directly communicate with each other. However, depending on a connection method of switches 118, it is also possible to cause all lower storage devices 121 in the upper storage device 101 to be accessible. In this case, all the lower storage devices 121 may be configured as one huge path group 119, or a set of lower storage devices 121 which are in a relation of being closely connected, that is, which have a large number of communication channels or have communication channels with the high throughput may be configured as the path group 119.

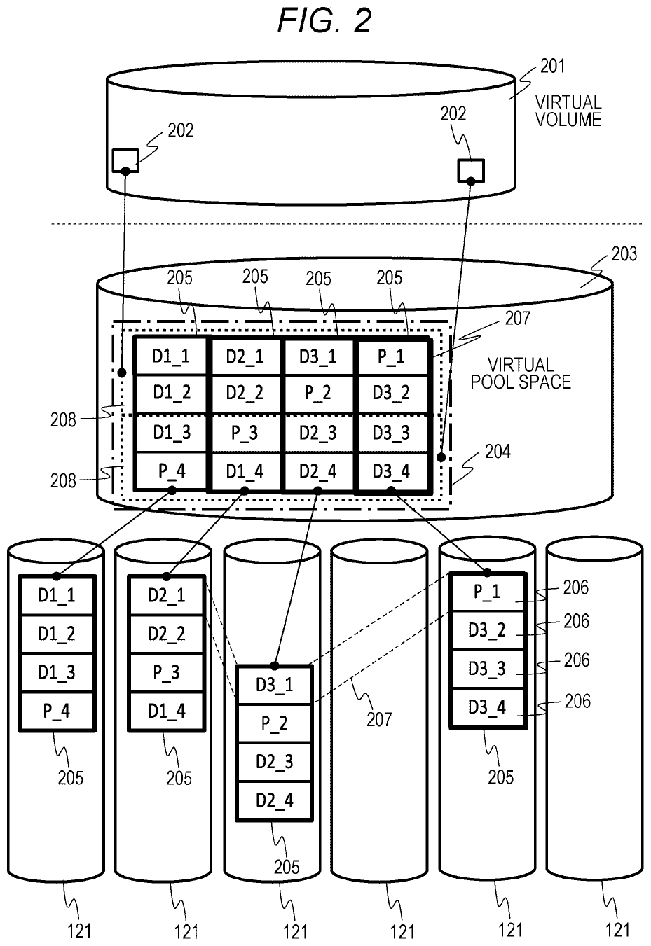

FIG. 2 is a logical configuration diagram of data according to the first embodiment.

A virtual volume 201 recognizable by the host 103 is configured by using a plurality of virtual pages (also referred to as virtual logical pages and logical pages) 202. A physical page 208 of a virtual pool space 203 is allocated to the virtual page 202. The virtual pool space 203 is configured by a storage area of a pool not shown in the drawings. In the virtual pool space 203, one or more extents 204 are managed. The extent 204 is configured by a plurality of parcels 205. The parcel 205 is configured by a continuous area on one storage device (for example, the lower storage device 121). The parcel 205 includes one or more stripes 206 (four stripes 206 in the example of FIG. 2).

As shown in FIG. 2, when the extent 204 has a 3D+1P configuration of the RAID 5, that is, a configuration in which three data elements (D) configuring a data unit and one parity (P) corresponding to these data elements are stored in different storage devices, respectively, the extent 204 is configured by the parcels 205 of the four different lower storage devices 121, for example. In the present embodiment, since the configuration of the distribution RAID is adopted, the extent 204 is configured by the parcels 205 of the four different lower storage devices 121 among the plurality of (the number more than four required at least for 3D+1P, for example, six) lower storage devices 121 configuring the storage area of the virtual pool space 203, and a combination of the lower storage devices 121 including the parcels 205 configuring each extent 204 is not fixed.

The extent 204 includes a plurality of (for example, two) physical pages 208. The physical page 208 can store data elements and parity (data of the same stripe row 207) of a plurality of (for example, two) consecutive data units. In the same drawing, like D1_1, D2_1, D3_1, and P_1, common numerals after “_” indicate data elements and parity in the same data unit. Each of the data element and the parity has a size of the stripe 206. The extent 204 may store data of one stripe row 207.

In the present embodiment, the case of adopting the configuration of the distribution RAID is described as an example. However, the present invention is applicable to even the case where the configuration of the distribution RAID is not adopted, in other words, the case where the extent 204 is configured by the parcels 205 of a plurality of (four required at least for 3D+1P) lower storage devices 121 configuring the storage area of the virtual pool space 203.

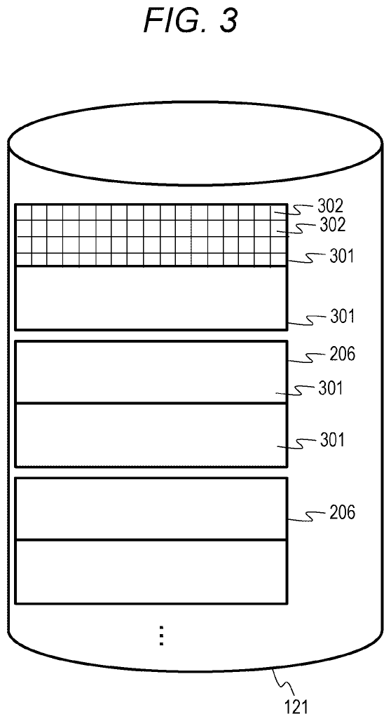

FIG. 3 is a logical configuration diagram of data in the lower storage device according to the first embodiment.

The lower storage device 121 can exchange data with the upper device in a unit of a sub-block 302 to be a minimum unit (for example, 512 B) of SCSI command processing. A slot 301 that is a management unit (for example, 256 KB) when data on the cache memory 113 is cached is configured by a set of a plurality of continuous sub-blocks 302. The stripes 206 are stored in a plurality of slots 301. The size of the stripe 206 is 512 KB when two slots 301 are provided, for example.

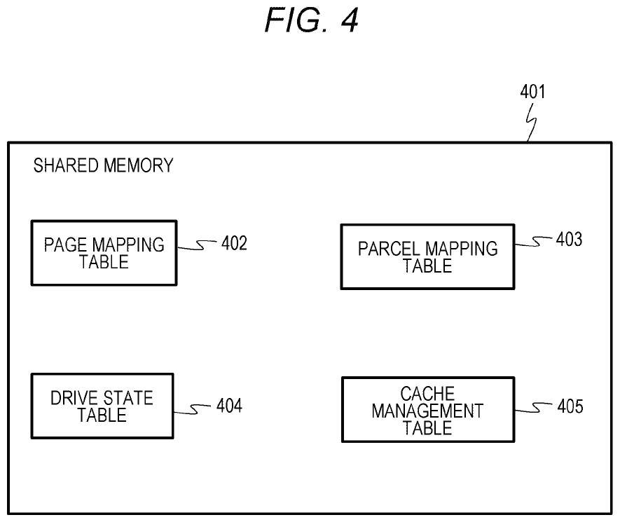

FIG. 4 is a diagram showing a table of a shared memory according to the first embodiment.

The shared memory 401 is configured by using, for example, at least one storage area of the lower storage device 121, the CM 113, and the local memory 116. The logical shared memory 401 may be configured by using storage areas of a plurality of configurations in the lower storage device 121, the CM 113, and the local memory 116, and cache management may be performed on various information.

The shared memory 401 stores a page mapping table 402, a parcel mapping table 403, a drive state table 404, and a cache management table 405. The details of each table will be described subsequently.

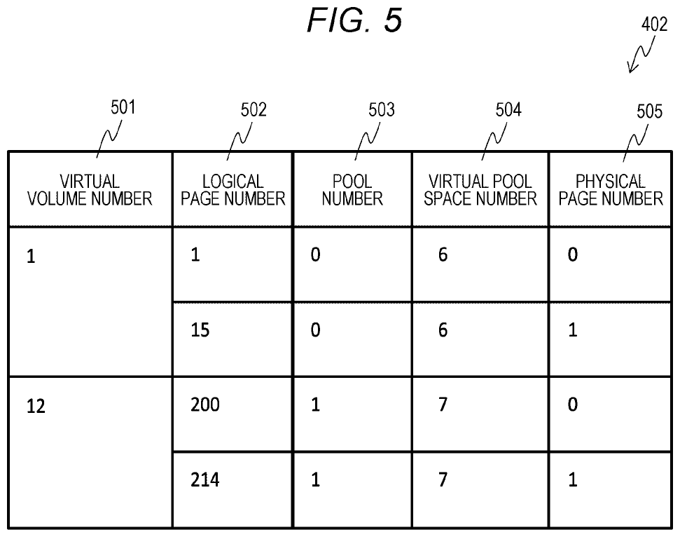

FIG. 5 is a diagram showing an example of a page mapping table according to the first embodiment.

The page mapping table 402 is information indicating a correspondence relation between the logical page 202 of the virtual volume 201 and the physical page 208 of the virtual pool space 203. The page mapping table 402 manages entries including fields of a virtual volume number 501, a logical page number 502, a pool number 503, a virtual pool space number 504, and a physical page number 505.

The virtual volume number 501 stores a number of the virtual volume 201 (virtual volume number). The logical page number 502 stores a number of the logical page (logical page number) in the virtual volume 201 indicated by the virtual volume number of the virtual volume number 501 in the entry. The pool number 503 stores a number of the pool including the physical page allocated to the logical page corresponding to the logical page number of the logical page number 502 in the entry. The virtual pool space number 504 stores a number of the virtual pool space (virtual pool space number) including the physical page allocated to the logical page corresponding to the logical page number of the logical page number 502 in the pool of the pool number of the pool number 503 in the entry. The physical page number 505 stores a number of the physical page (physical page number) allocated to the logical page corresponding to the logical page number of the logical page number 502 in the entry. The physical page number is, for example, an LBA (address in a unit of a sub-block).

According to the entry at the top of FIG. 5, it can be seen that a physical page having a physical page number “0” in a virtual pool space having a virtual pool space number “6” in a pool having a pool number “0” is allocated to a logical page having a logical page number “1” in a virtual volume having a virtual volume number “1”.

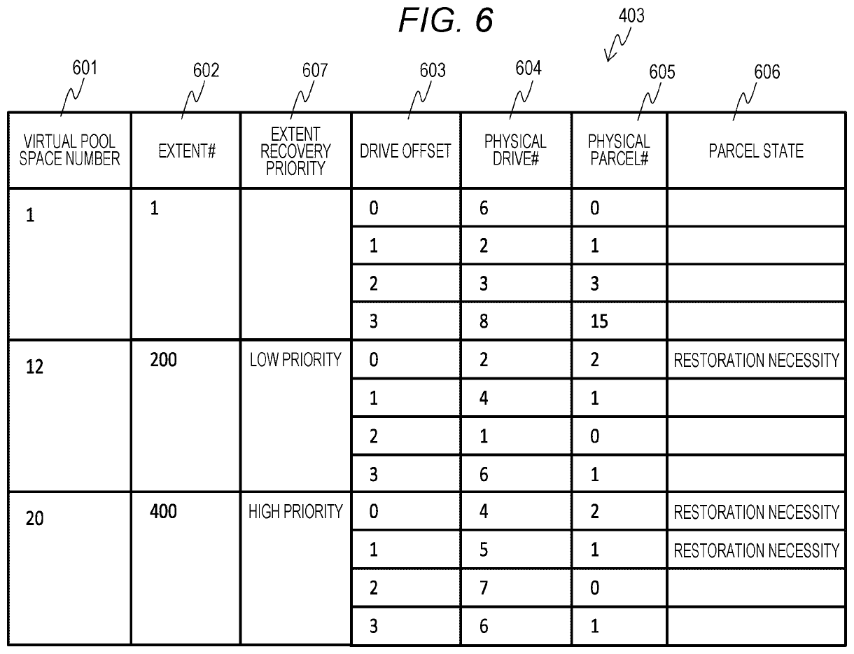

FIG. 6 is a diagram showing an example of a parcel mapping table according to the first embodiment.

The parcel mapping table 403 is a table for managing the parcels 205 allocated to the extent 204. The parcel mapping table 403 manages entries including fields of a virtual pool space number 601, an extent number (#) 602, an extent recovery priority 607, a drive offset 603, a physical drive number (#) 604, a physical parcel number (#) 605, and a parcel state 606.

The virtual pool space number 601 stores a number of the virtual pool space 203 (virtual pool space number). The extent # 602 stores a number of the extent 204 (extent number) in the virtual pool space 203 corresponding to the virtual pool space number of the virtual pool space number 601 in the entry. The extent recovery priority 607 stores a recovery priority of the extent 204 corresponding to the extent number of the extent # 602 in the entry. In the present embodiment, in the extent recovery priority 607, a “high priority” is set to the case of the extent 204 in which restoration is preferentially necessary among a plurality of extents (referred to as failed extents) in which data elements stored in the parcels 205 configuring the extent 204 are failed and restoration is necessary, and a “low priority” is set to the case of the extent 204 in which restoration is necessary, but preferential restoration is unnecessary. In the extent recovery priority 607, a blank is set to the case of the extent 204 in which restoration is unnecessary for the data elements stored in the parcels 205 configuring the extent 204. For example, when the lower storage device 121 is in a failure state, the MP 115 refers to the parcel state 606 of the entry corresponding to the extent 204, and sets a “low priority” or a “high priority” to the extent recovery priority 607.

The drive offset 603 stores a number of the drive offset (drive offset number) in the extent 204 corresponding to the extent number of the extent # 602 in the entry. Here, the drive offset number is a number indicating which drive (lower storage device 121) of the configuration (for example, 3D+1P) of the RAID group is used. In the present embodiment, as drive offset numbers for one extent of one virtual pool space 203, four drive offset numbers of 0 to 3 are managed in association with each other. The physical drive # 604 stores a number of the drive (for example, the lower storage device 121) (physical drive number) storing the parcel 205 allocated to the drive of the drive offset number of the drive offset 603 in the entry. The physical parcel # 605 stores a number of the parcel 205 allocated to the drive of the drive offset number. The parcel state 606 stores a state of the parcel 205 corresponding to the physical parcel number of the physical parcel # 605 in the entry. In the present embodiment, in the parcel state 606, “restoration necessity” is set to the case where restoration is necessary for the data element stored in the parcel 205, and a blank is set to the other cases. For example, when the lower storage device 121 is in a failure state, the MP 115 sets “restoration necessity” to the parcel state 606 of the entry corresponding to the parcel 205 of the lower storage device 121.

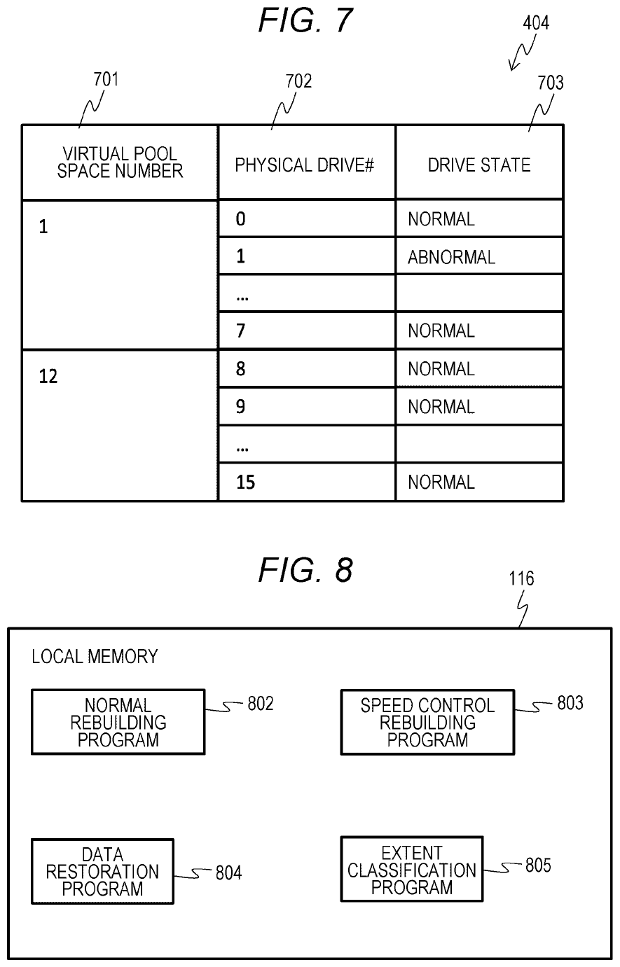

FIG. 7 is a diagram showing an example of a drive state table according to the first embodiment.

The drive state table 404 is a table for managing states of the drives (for example, the lower storage devices 121) that configure the virtual pool space 203. The drive state table 404 manages entries including fields of a virtual pool space number 701, a physical drive number (#) 702, and a drive state 703. The virtual pool space number 701 stores a number of the virtual pool space 203 (virtual pool space number). The physical drive number 702 stores a number of the drive (physical drive number) configuring the virtual pool space 203 corresponding to the virtual pool space number of the virtual pool space number 701 in the entry. The drive state 703 stores the state of the drive corresponding to the physical drive number of the physical drive number 702 in the entry. As the state of the drive, “normal” indicating that the drive is normal or “abnormal” indicating that reading and writing with respect to the drive are impossible is set.

FIG. 8 is a configuration diagram of a local memory according to the first embodiment.

The local memory 116 stores a normal rebuilding program 802, a speed control rebuilding program 803, a data restoration program 804, and an extent classification program 805. Here, the speed control rebuilding program 803, the data restoration program 804, and the extent classification program 805 are an example of the data management program.

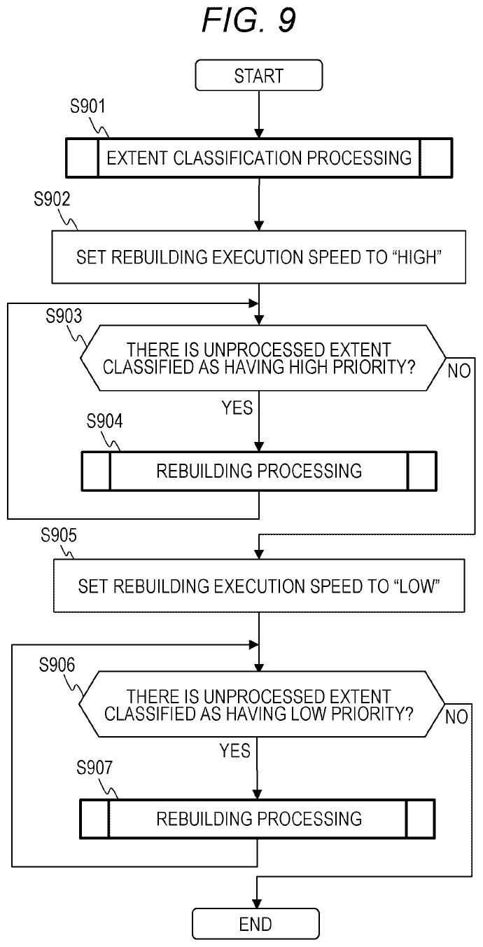

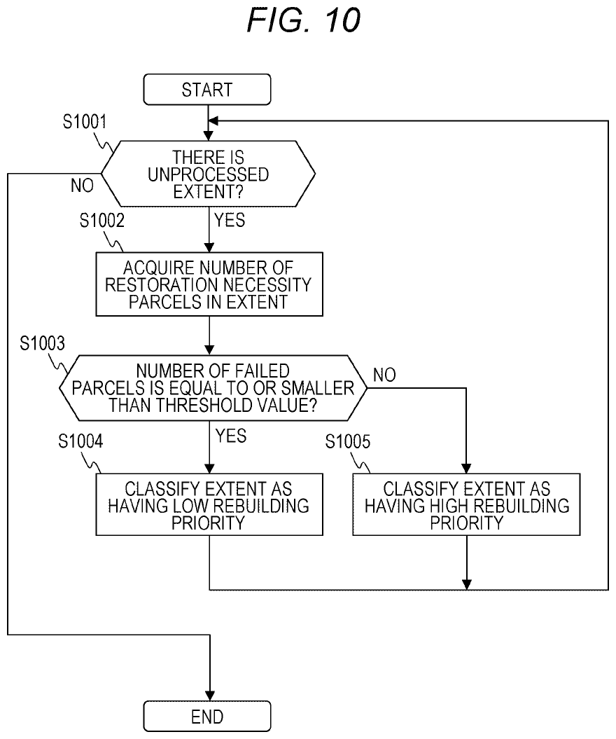

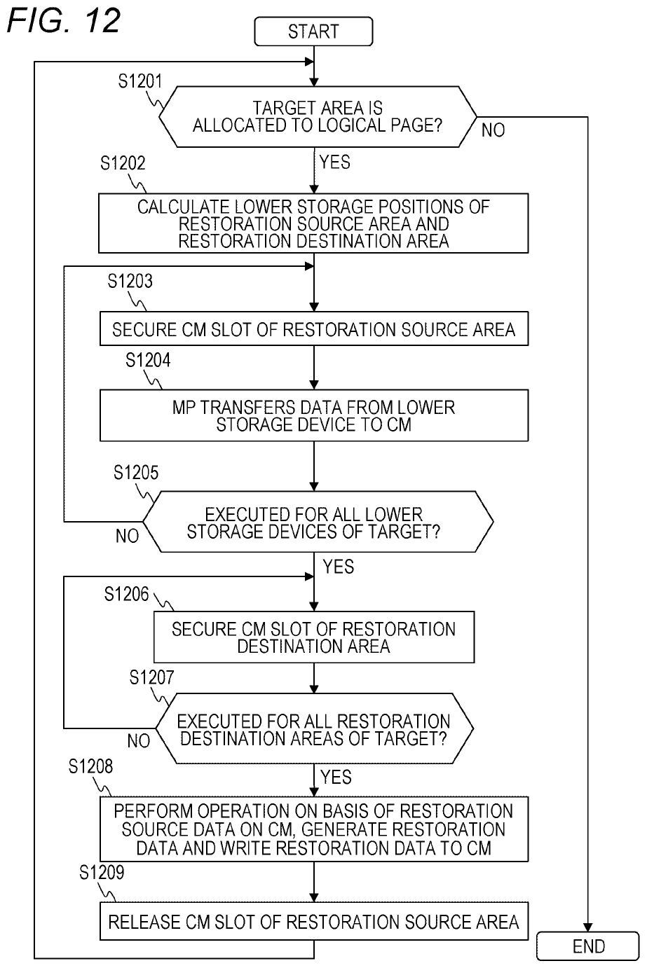

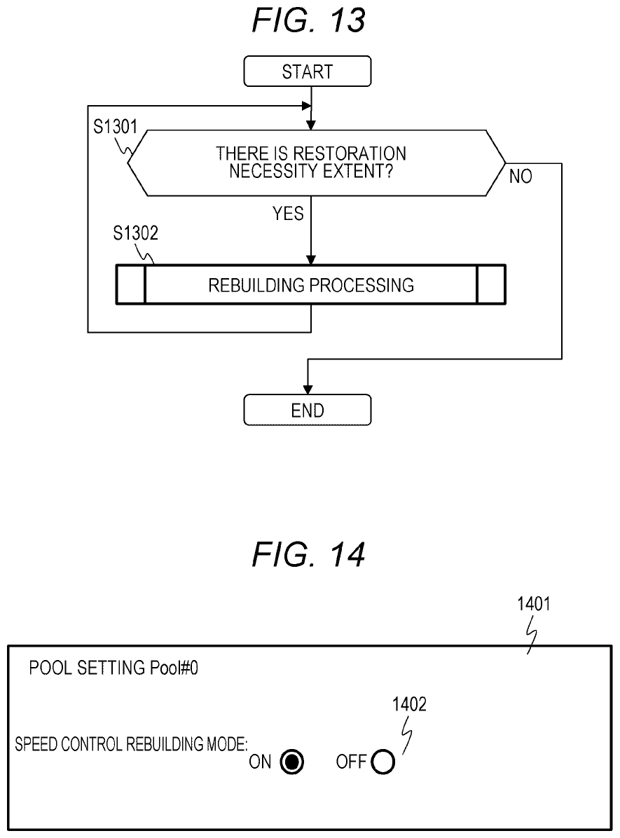

The normal rebuilding program 802 is a program for executing normal rebuilding processing (refer to FIG. 13). The speed control rebuilding program 803 is a program for executing speed control rebuilding processing (refer to FIG. 9). The data restoration program 804 is a program for executing data restoration processing (refer to FIG. 12). The extent classification program 805 is a program for executing extent classification processing (refer to FIG. 10).

Next, an operation of processing in the computer system according to the first embodiment will be described.

FIG. 9 is a flowchart showing the speed control rebuilding processing according to the first embodiment. The speed control rebuilding processing is executed when the upper storage device 101 detects that one or more lower storage devices 121 have failed (read or write is disabled), for example.

Before the execution of this processing, the physical drive state 703 in the entry of the physical drive number 604 of the entry in which the failed drive number of the drive state management table 404 is stored is set to “abnormal” by the upper storage device 101, and in the parcel state 606 stored in the parcel mapping table 403, the parcel state 606 of the entry corresponding to the physical parcel number of the physical parcel 205 stored in the drive in which the physical drive state 703 is set to “abnormal” is set to “abnormal”.

In the speed control rebuilding processing, first, the MP 115 executes the extent classification processing (refer to FIG. 10) (step S901). By the extent classification processing, the extents 204 including the parcels 205 of which the parcel state 606 is “restoration necessity” are classified with respect to the rebuilding priority.

Next, in step S902, the MP 115 sets an execution speed of rebuilding to “high”. Here, if the execution speed of rebuilding is “high”, it indicates that I/O in the rebuilding processing is executed with the higher throughput than the case where the execution speed of rebuilding is “low”, by control to increase an allowable value of a ratio of issuing of I/O to the lower storage device 121 relating to the rebuilding processing by the MP 115 with respect to I/O from the host 103, increase an execution priority in the MP 115 (for example, an execution priority in an OS executed by the MP 115) for the rebuilding processing, or increase an amount of hardware resources (an MP, a memory, and the like) allocated to the rebuilding processing by the MP 115.

Next, the MP 115 determines whether or not there is an extent 204 for which the processing of step S904 is not executed, among the extents 204 of which the priorities have been classified as “high” in the extent classification processing (step S901) (step S903). Here, whether or not there is the extent 204 of which the priority is “high” can be determined by determining whether or not the “high priority” is set to the extent recovery priority entry 607 of the entry corresponding to the extent of the parcel mapping table 403.

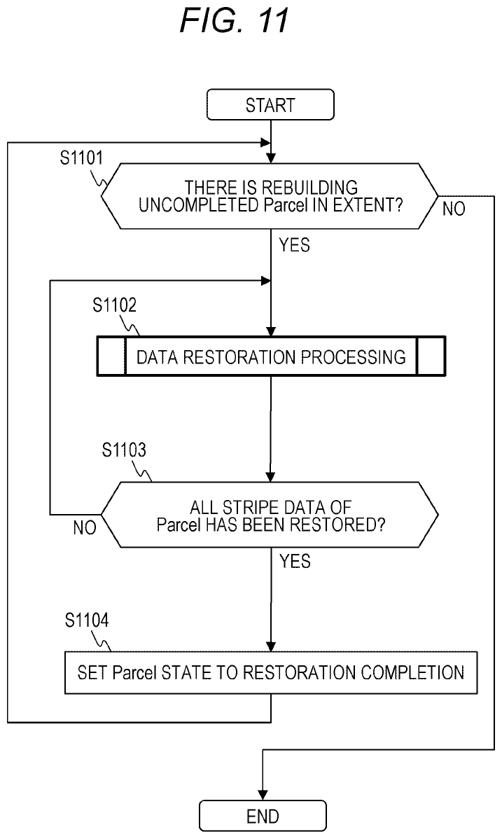

As a result of the determination, when there is an unprocessed extent 204 in the extents 204 of which the priorities have been classified as “high” (step S903: YES), the MP 115 executes the rebuilding processing (refer to FIG. 11) on one target extent among the extents 204 of which the priorities have been classified as “high” (step S904). The rebuilding processing is completed, so that all the parcels 205 included in the target extent 204 of which the priority has been classified as “high” are in a “normal” state.

On the other hand, when there is no unprocessed extent 204 in the extents 204 of which the priorities have been classified as “high” (step S903: NO), the MP 115 advances the processing to step S905.

In step S905, the MP 115 sets the execution speed of rebuilding to “low”. Here, if the execution speed of rebuilding is “low”, it indicates that the rebuilding processing is executed with the lower throughput than the case where the execution speed of rebuilding is “high”, by control to decrease an allowable value of a ratio of issuing of I/O to the lower storage device 121 relating to the rebuilding processing by the MP 115 with respect to I/O from the host 103, decrease an execution priority in the MP 115 (for example, an execution priority in an OS executed by the MP 115) for the rebuilding processing, or decrease an amount of hardware resources (an MP, a memory, and the like) allocated to the rebuilding processing by the MP 115. If the execution speed of rebuilding is “low”, it can also be said that an allowable load for I/O is lower than that when the execution speed of rebuilding is “high”.

Next, the MP 115 determines whether or not there is an extent 204 for which the processing of step S907 is not executed, among the extents 204 of which the priorities have been classified as “low” in the extent classification processing (step S901) (step S906). Here, whether or not there is the extent 204 of which the priority is “low” can be determined by determining whether or not the “low priority” is set to the extent recovery priority entry 607 of the entry corresponding to the extent of the parcel mapping table 403.

As a result of the determination, when there is an unprocessed extent 204 in the extents 204 of which the priorities have been classified as “low” (step S906: YES), the MP 115 executes the rebuilding processing (refer to FIG. 11) on one target extent among the extents 204 of which the priorities have been classified as “low” (step S907). The rebuilding processing is completed, so that all the physical parcels 205 included in the target extent 204 of which the priority has been classified as “low” are in a “normal” state.

On the other hand, when there is no unprocessed extent 204 in the extents 204 of which the priorities have been classified as “low” (step S906: NO), the MP 115 ends the speed control rebuilding processing.

According to the speed control rebuilding processing described above, with respect to the extent having the priority of “high”, the rebuilding processing is performed with the high throughput, so that rebuilding can be performed early and reliability can be improved. With respect to the extent having the priority of “low”, the rebuilding processing is performed with the low throughput, so that it is possible to reduce performance degradation for I/O from the host 103.

Next, the extent classification processing (S901) will be described in detail.

FIG. 10 is a flowchart showing the extent classification processing according to the first embodiment.

In the extent classification processing, with respect to the extent 204 including the parcels 205 of “restoration necessity”, the necessity of rebuilding is determined by determining whether or not the number of parcels 205 of which the parcel state 606 of the parcel mapping table 403 is “restoration necessity” among the parcels 205 configuring the extent 204 exceeds a threshold value. When the number of parcels 205 exceeds the threshold value, the extent 204 is classified as having the rebuilding priority of “high”, and when the number of parcels 205 does not exceed the threshold value, the extent 204 is classified as having the rebuilding priority of “low”. The details will be described below.

The MP 115 determines whether or not there are unprocessed extents not classified by the extent classification processing in the extents 204 including the parcels 205 of “restoration necessity” (S1001). When there are the unprocessed extents (step S1001: YES), the MP 115 selects one extent 204 of a processing target from the unprocessed extents 204, refers to the parcel mapping table 403, specifies the parcels 205 configuring the extent 204 of the processing target, and acquires the number of parcels 205 in which the parcel state 606 of the specified parcels 205 is “restoration necessity” (step S1002).

Next, the MP 115 determines whether the number of parcels of which the parcel state 606 is “restoration necessity” is equal to or less than a threshold value (step S1003).

As a result, when the number of parcels of which the parcel state 606 is “restoration necessity” is equal to or less than a threshold value (step S1003: YES), there is a relatively long time until data cannot be restored, with respect to the target extent. For this reason, the rebuilding priority is classified as “low”, the “low priority” is set to the extent recovery priority 607 of the entry corresponding to the target extent of the parcel mapping table 403 (step S1004), and the processing proceeds to step S1001.

On the other hand, when the number of parcels of which the parcel state 606 is “restoration necessity” exceeds the threshold value (step S1003: NO), there is no time or little time until data cannot be restored, with respect to the target extent. For this reason, the rebuilding priority is classified as “high”, the “high priority” is set to the extent recovery priority 607 of the entry corresponding to the target extent of the parcel mapping table 403 (step S1005), and the processing proceeds to step S1001.

When there is no extent 204 not classified (step S1001: NO), the MP 115 ends the extent classification processing.

Here, 1 may be set as the threshold value used in step S1003, for example, when the extent 204 is configured by the configuration of the RAID 6 and a data redundancy is 2. In the case where there are two parcels 205 of “restoration necessity” in the extent 204, if one parcel 205 newly becomes “restoration necessity” and cannot be read, data restoration may become impossible. For this reason, the parcel 205 needs to be recovered early, and the rebuilding priority may be classified as “high”. On the other hand, in the case where there is one parcel 205 of “restoration necessity” in the extent 204, even if one parcel 205 newly becomes “restoration necessity” and cannot be read, data can be restored from the remaining parcels 205. Therefore, the priority may be classified as “low”.

Next, the rebuilding processing (steps S904 and S907) will be described in detail.

FIG. 11 is a flowchart showing the rebuilding processing according to the first embodiment.

In the rebuilding processing, the MP 115 executes (controls) the processing according to the set rebuilding speed. First, the MP 115 refers to the parcel mapping table 403 and determines whether or not there is a parcel 205 for which rebuilding is not completed in the extent 204 of the processing target, that is, whether or not there is a parcel 205 of which the parcel state is “restoration necessity” (step S1101). As a result, when there is no parcel 205 for which rebuilding is not completed (step S1101: NO), the MP 115 ends the rebuilding processing.

On the other hand, when there is the parcel 205 for which rebuilding is not completed (step S1101: YES), the MP 115 executes the data restoration processing (refer to FIG. 12) for data (stripe data element) of one stripe 206 of one parcel 205 for which rebuilding is not completed (step S1102).

Next, the MP 115 determines whether or not data of all the stripes 206 of the parcel 205 has been restored (step S1103).

As a result, when the data of all the stripes has not been restored (step S1103: NO), the MP 115 advances the processing to step S1102. On the other hand, when the data of all the stripes 206 of the parcel 205 has been restored (step S1103: YES), the MP 115 sets the parcel state 606 of the entry corresponding to the parcel 205 of the parcel mapping table 403 to content (in the present embodiment, a blank) indicating restoration completion (“restoration unnecessity”) (step S1104), and advances the processing to step S1101.

In the rebuilding processing shown in FIG. 11, the data restoration processing (S1102) is sequentially executed for each parcel 205 for which the rebuilding is not completed. However, the present invention is not limited thereto, and a plurality of data restoration processing may be executed in parallel for a plurality of parcels 225 for which rebuilding is not completed. In this way, the time of the rebuilding processing for the plurality of parcels 205 can be reduced. Further, in the case where the data restoration processing is executed in parallel, the parcel 205 set as a target of the certain data restoration processing may be selected from the parcels 205 of the lower storage devices 121 other than the lower storage devices 121 having the parcels 205 (a restoration source parcel and a restoration destination parcel) used in other data restoration processing. In this way, it is possible to reduce the collision of accesses to the lower storage devices 121 and to improve the parallel effect of the data restoration processing on the plurality of parcels 205. As a result, the time of the rebuilding processing can be effectively shortened.

Next, the data restoration processing (step S1102) will be described in detail.

FIG. 12 is a flowchart showing the data restoration processing according to the first embodiment.

In the data restoration processing, the MP 115 executes (controls) the processing according to the set rebuilding speed. First, the MP 115 determines whether or not the stripe 206 of the parcel 205 of the restoration target is allocated to a logical page (step S1201). Here, whether or not the stripe 206 of the parcel 205 of the restoration target is allocated to the logical page can be grasped by specifying the virtual pool space number corresponding to the stripe 206 of the parcel 205 of the restoration target, the extent number, and the drive offset If with reference to the parcel mapping table 403, specifying the physical page number on the basis of the extent number and the drive offset #, and specifying whether or not the logical page number is associated with the specified physical page number with reference to the page mapping table 402.

As a result, when the stripe 206 of the parcel 205 of the restoration target is not allocated to the logical page (step S1201: NO), the MP 115 ends the data restoration processing.

On the other hand, when the stripe 206 of the parcel 205 of the restoration target is allocated to the logical page (step S1201: YES), the MP 115 calculates, from the parcel mapping table 403, the lower storage devices 121 storing the restoration source area and the restoration destination area and the positions of the restoration source area and the restoration destination area in the lower storage devices 121 (step S1202).

Next, the MP 115 secures a cache slot for storing data of the restoration source area in the CM 113, and acquires a lock of the secured cache slot (step S1203). Next, the MP 115 transfers data elements and/or parity of the restoration source area from the lower storage device 121 of the restoration source area to the cache slot of which the lock has been acquired via the transfer buffer 110 (step S1204).

Next, the MP 115 determines whether or not data elements and/or parity of the restoration source areas has been transferred from the lower storage devices 121 of all restoration source areas (step S1205).

As a result, when the data elements and/or the parity of the restoration source areas has not been transferred from the lower storage devices 121 of all the restoration source areas (step S1205: NO), the MP 115 advances the processing to step S1203, and executes the processing on the lower storage devices 121 of the restoration source areas to be the processing target.

On the other hand, when the data elements and/or the parity of the restoration source areas has been transferred from the lower storage devices 121 of all the restoration source areas (step S1205: YES), the MP 115 advances the processing to step S1206.

In step S1206, the MP 115 sets one of the restoration destination areas not to be the processing target as the processing target and secures a cache slot for storing data of the restoration destination area in the CM 113. Next, the MP 115 determines whether or not the cache slots of all the restoration destination areas have been secured (step S1207). As a result, when the cache slots of all the restoration destination areas have not been secured (step S1207: NO), the MP 115 advances the processing to step S1206.

On the other hand, when the cache slots of all the restoration destination areas have been secured (step S1207: YES), the MP 115 generates restoration data by executing operation processing to restore data, on the basis of the data elements and the parity of the plurality of restoration source areas on the CM 113, and stores the generated restoration data in the cache slot of the restoration destination of the CM 113 (step S1208). The MP 115 performs processing of writing the restoration data stored in the CM 113 to the lower storage device 121 thereafter. At this time, the MP 115 collectively writes the restoration data for the plurality of restoration destination areas to the lower storage devices 121, so that it is possible to improve write efficiency to the lower storage devices 121.

Next, the MP 115 releases the cache slot of the CM 113 storing the data of the restoration source area (step S1209), and advances the processing to step S1201.

Next, the normal rebuilding processing will be described in detail.

FIG. 13 is a flowchart showing an example of the normal rebuilding processing according to the first embodiment.

The normal rebuilding processing is processing executed when the upper storage device 101 is not set to execute the speed control rebuilding processing.

In the normal rebuilding processing, the MP 115 refers to the parcel mapping table 403 and determines whether or not there is a parcel 205 of which the parcel state 606 is “restoration necessity” (S1301). As a result, when there is no parcel of which the parcel state 606 is “restoration necessity” (step S1301: NO), the MP 115 ends the normal rebuilding processing. On the other hand, when there is the parcel 205 of which the parcel state 606 is “restoration necessity” (step S1301: YES), the MP 115 executes the rebuilding processing shown in FIG. 11 on the extent including the parcel 205 of “restoration necessity” (step S1302), and advances the processing to step S1301. In the rebuilding processing in step S1302, the MP 115 executes (controls) the processing with the rebuilding execution speed set as “high”.

According to the normal rebuilding processing, the restoration processing can be performed at the same speed with respect to the extent including the parcels that need to be restored. In the present embodiment, the normal rebuilding processing and the speed control rebuilding processing can be changed by setting. Therefore, for example, when degradation of the I/O performance to the host 103 does not cause a problem, the normal rebuilding processing is executed, so that it is possible to early end rebuilding for all the extents 204 that need to be restored.

Next, a management screen of the management server 102 for setting the rebuilding processing will be described.

FIG. 14 is a diagram showing an example of the management screen of the management server according to the first embodiment.

A management screen 1401 is a screen displayed on the management server 102 in order for a user to designate a mode of the rebuilding processing for data units managed in an area belonging to a pool in a pool unit. The management screen 1401 has a data restoration processing setting area 1402 where a radio button to designate whether to set a speed control rebuilding mode, that is, to set “ON” to execute speed control rebuilding processing or not to execute the speed control rebuilding processing, that is, to set “OFF” to execute the normal rebuilding processing is displayed. In the data restoration processing setting area 1402, if the user selects the radio button by an input unit not shown in the drawing, setting content corresponding to the selection is transmitted from the management server 102 to the upper storage device 101, and is managed by the LM 116, for example. In the case where the rebuilding processing is executed when the lower storage device 121 fails, the MP 115 refers to the setting content of the LM 116 to execute the rebuilding processing corresponding to the setting content. FIG. 14 shows the management screen which enables setting of a mode of the rebuilding processing in the pool unit, but the present invention is not limited thereto. For example, the management screen may be set as a screen enabling setting of the mode of the rebuilding processing in a unit of a virtual volume, and the MP 115 may execute the rebuilding processing in a unit of a virtual volume according to the setting content.

As described above, according to the upper storage device 101 according to the first embodiment, by performing rebuilding of the extent with the high rebuilding priority at high speed to complete rebuilding in a short time, data reliability is secured early. By performing rebuilding at low speed for the extent with the low rebuilding priority, the collision with I/O caused by I/O from the host 103 at the time of rebuilding execution can be reduced, and degradation of the I/O performance to the host 103 can be suppressed.

In the first embodiment described above, an example is shown in which the rebuilding priority is set to two steps of “high” and “low” in the extent classification processing (step S901). However, the rebuilding priority may be classified as three or more steps of “high”, “medium”, and “low”. In this case, the rebuilding processing speeds for the priorities may be set to “high”, “medium”, and “low”, respectively.

### Second Embodiment

Next, a computer system according to a second embodiment will be described.

The second embodiment is an embodiment in which a rebuilding priority to determine a rebuilding speed is determined by the number of failed drives (lower storage devices 121), in the first embodiment. The description of portions common to the first embodiment will be omitted or simplified.

Speed control rebuilding processing in an upper storage device 101 according to the second embodiment will be described.

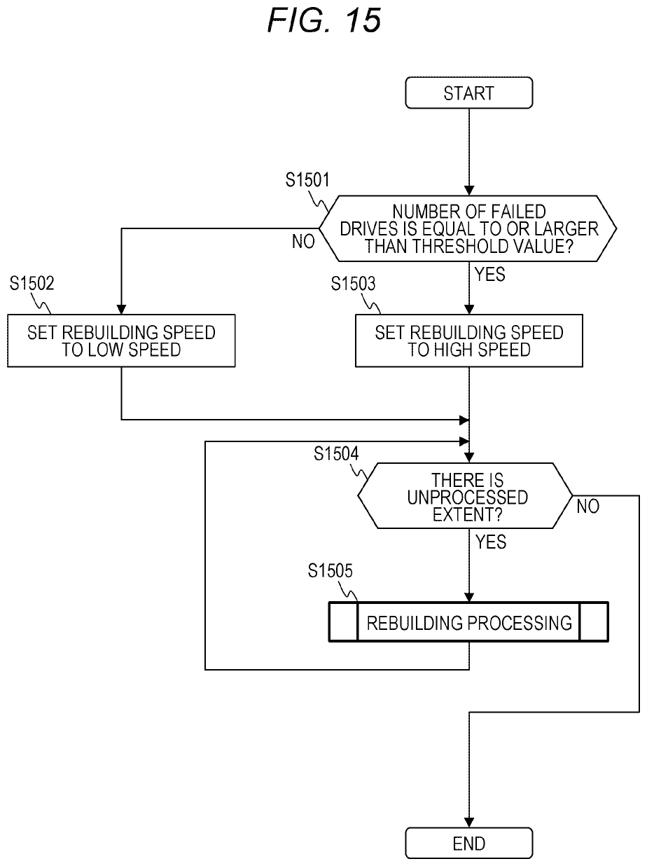

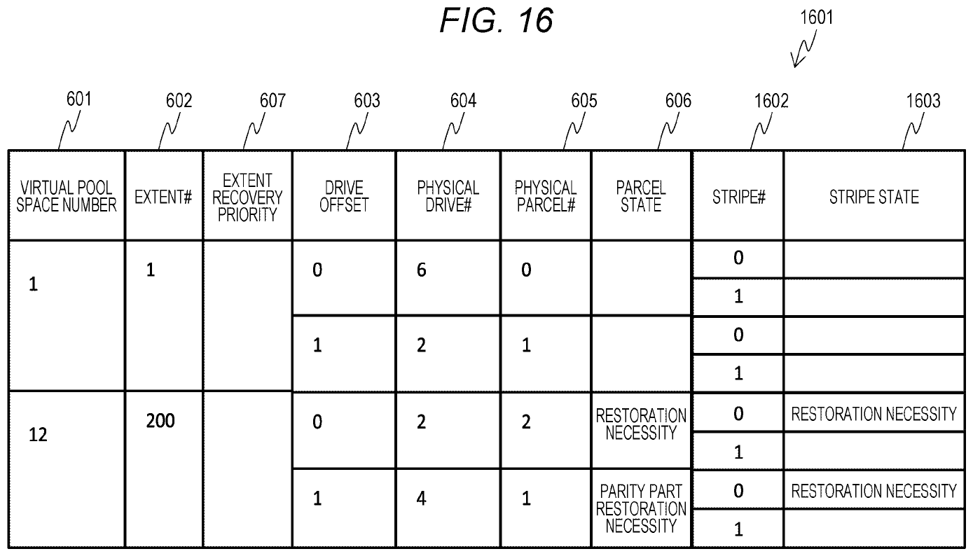

FIG. 15 is a flowchart showing the speed control rebuilding processing according to the second embodiment.

In the speed control rebuilding processing, first, an MP 115 specifies the number of failed drives, and determines whether the number of failed drives is equal to or more than a threshold value (step S1501). Here, the number of failed drives can be specified by referring to a drive state table 404 and counting the number of drives of which a drive state 703 is “abnormal”. As the threshold value used in step S1501, for example, when an extent 204 is configured by a configuration of RAID 6 and a data redundancy is 2, the threshold value may be 2, and when the extent 204 is configured by a configuration of RAID 5 and a data redundancy is 1, the threshold value may be 1.

As a result of determination in step S1501, when the number of failed drives is less than the threshold value (step S1501: NO), there is a long time until data cannot be restored. For this reason, the MP 115 sets a rebuilding execution speed to “low” (step S1502), and advances the processing to step S1504. On the other hand, when the number of failed drives is equal to or more than the threshold value (step S1501: YES), there is no time or little time until data cannot be restored. For this reason, the MP 115 sets the rebuilding execution speed to “high” (step S1503), and advances the processing to step S1504.

In step S1504, the MP 115 determines whether or not there is an extent on which the rebuilding processing is not executed. When there is the extent on which the rebuilding processing is not executed (step S1504: YES), the MP 115 executes the rebuilding processing (refer to FIG. 11) of the data on the extent 204 (S1505), and advances the processing to step S1504. The rebuilding processing is completed, so that all parcels 205 included in the extent 204 are in a “normal” state. On the other hand, when there is no extent on which the rebuilding processing is not executed (step S1504: NO), the MP 115 ends the speed control rebuilding processing.

As described above, in the second embodiment, when the number of failed drives is sufficiently less than the data redundancy, rebuilding is executed at low speed, so that the collision with I/O caused by I/O from a host 103 during the rebuilding execution can be reduced, and degradation of I/O performance to the host 103 can be suppressed. Further, when the number of failed drives is the same as or close to the data redundancy, rebuilding is executed at high speed, so that data reliability can be improved early.

### Third Embodiment

Next, a computer system according to a third embodiment will be described.

The third embodiment is an embodiment in which an execution priority of rebuilding processing is determined according to whether a stripe 206 included in a failed drive is a data part or a parity part, in a first embodiment. The description of portions common to the first embodiment will be omitted.

An upper storage device 101 according to the third embodiment includes a parcel mapping table 1601 instead of a parcel mapping table 403 according to the first embodiment.

FIG. 16 is a diagram showing an example of a parcel mapping table according to the third embodiment. Elements common to the first embodiment will be denoted with the same reference numerals, and the redundant description will be omitted.

The parcel mapping table 1601 manages entries including fields of a virtual pool space number 601, an extent number (#) 602, an extent recovery priority 607, a drive offset 603, a physical drive number (#) 604, a physical parcel number (#) 605, a parcel state 606, a stripe number (#) 1602, and a stripe state 1603.

The stripe # 1602 stores a number (stripe number) for identifying a stripe 206 included in a parcel 205 indicated by the physical parcel number of the physical parcel # 605 of the entry. The stripe state 1603 stores a state of the stripe 206 corresponding to the stripe number in the entry. In the present embodiment, in the stripe state 1603, “restoration necessity” is set to the case where restoration is necessary for the data element stored in the stripe 206, and a blank is set to the other cases. For example, when a lower storage device 121 is in a failure state, an MP 115 sets “restoration necessity” to the stripe state 1603 of the entry corresponding to a stripe of the lower storage device 121. Further, in the present embodiment, in the parcel state 606, “restoration necessity” is set to the case where restoration is necessary for the data element stored in the parcel 205, “parity part restoration necessity” is set to the case where there is a possibility that restoration is necessary for the parity part, and a blank is set to the other cases.

Next, speed control rebuilding processing according to the third embodiment will be described.

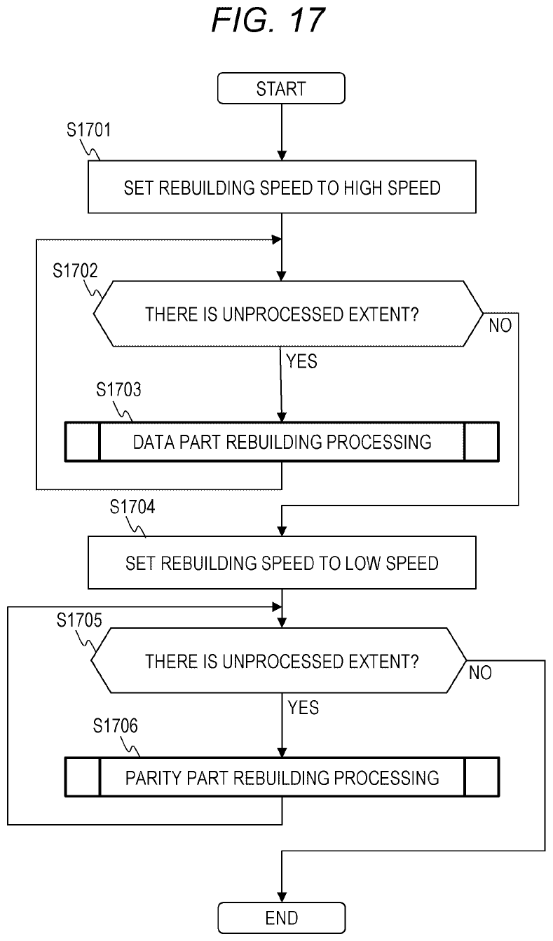

FIG. 17 is a flowchart showing an example of the speed control rebuilding processing according to the third embodiment.

The speed control rebuilding processing is executed by the MP 115 at arbitrary timing.

In the speed control rebuilding processing, first, the MP 115 sets a rebuilding execution speed to “high” (step S1701). Next, the MP 115 determines whether or not there is an extent 204 for which the data part rebuilding processing (S1703) is not executed (step S1702). Here, whether or not there is the extent 204 for which the data part rebuilding processing is not executed can be determined by determining whether or not there is an extent 204 configured to include one or more parcels 205 of which the parcel state 606 is “restoration necessity”, with reference to the parcel mapping table 1601.

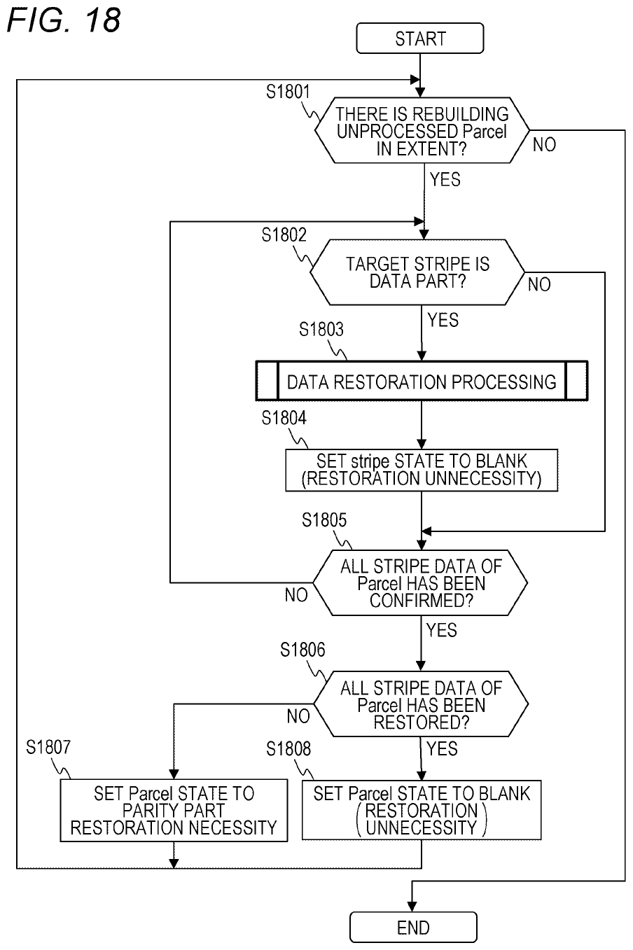

As a result, when there is the extent 204 for which the data part rebuilding processing is not executed (step S1702: YES), the MP 115 sets one extent 204 among the extents 204 for which the data part rebuilding processing is not executed as a processing target, executes the data part rebuilding processing (refer to FIG. 18) on the processing target (step S1703), and advances the processing to step S1702. All parcels configuring the extent for which the data part rebuilding processing has been completed are in a parcel state of either “blank (restoration unnecessity)” or “parity part restoration necessity”.

On the other hand, when there is no extent 204 for which the data part rebuilding processing is not executed (step S1702: NO), the MP 115 sets the rebuilding execution speed to “low” (step S1704).

Next, the MP 115 determines whether or not there is an extent 204 for which the parity part rebuilding processing (S1706) is not executed (step S1705). Here, whether or not there is the extent 204 for which the parity part rebuilding processing is not executed can be determined by determining whether or not there is an extent 204 configured to include one or more parcels 205 of which the parcel state 606 is “parity part restoration necessity”, with reference to the parcel mapping table 1601.

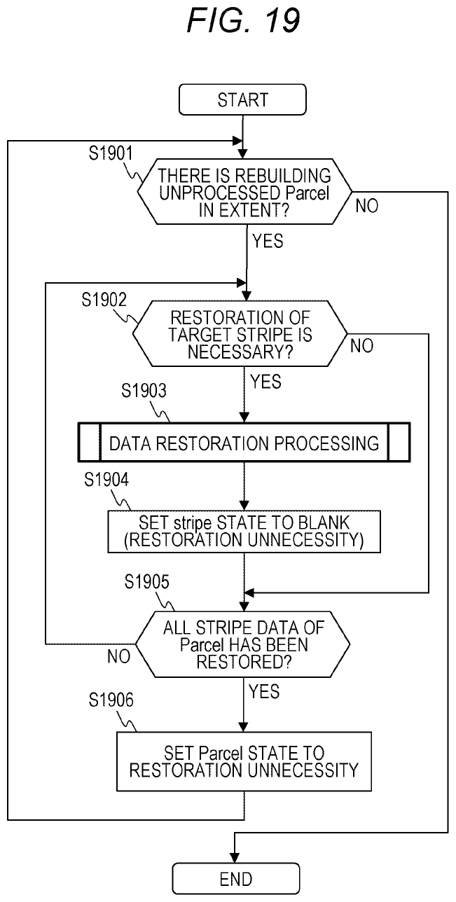

As a result, when there is the extent 204 for which the parity part rebuilding processing is not executed (step S1705: YES), the MP 115 sets one extent 204 among the extents 204 for which the parity part rebuilding processing is not executed as a processing target, executes the parity part rebuilding processing (refer to FIG. 19) on the processing target (step S1706), and advances the processing to step S1705. All parcels configuring the extent for which the parity part rebuilding processing has been completed are in a parcel state of “blank” (restoration unnecessity).

On the other hand, when there is no extent 204 on which the parity part rebuilding processing is not executed (step S1705: NO), the MP 115 ends the speed control rebuilding processing.

Next, the data part rebuilding processing (S1703) will be described in detail.

FIG. 18 is a flowchart showing an example of the data part rebuilding processing according to the third embodiment.

In the data part rebuilding processing, the MP 115 executes (controls) the rebuilding processing at high speed, according to setting of the rebuilding processing. The MP 115 refers to the parcel mapping table 1601 and determines whether or not there is a parcel 205 for which rebuilding is not completed in the extent 204 of the processing target, that is, whether or not there is a parcel 205 of which the parcel state is “restoration necessity” (step S1801). As a result, when there is no parcel 205 for which rebuilding is not completed (step S1801: NO), the MP 115 ends the data part rebuilding processing.

On the other hand, when there is the parcel 205 for which rebuilding is not completed (step S1801: YES), the MP 115 determines whether data (stripe data element) of one stripe 206 of one parcel 205 for which rebuilding is not completed is a data part or a parity part (step S1802).

As a result, when the stripe data element is the data part (step S1802: YES), the MP 115 executes data restoration processing (refer to FIG. 12) (step S1803). After the data restoration processing is completed, the MP 115 updates the stripe state 1603 of the entry corresponding to the stripe for which restoration has been completed in the parcel mapping table 1601, from “restoration necessity” to “blank (restoration unnecessity)” (step S1804), and advances the processing to step S1805.

On the other hand, when the stripe data element is not the data part (step S1802: NO), the MP 115 advances the processing to step S1805.

In step S1805, the MP 115 determines whether or not data of all the stripes 206 of the parcel 205 has been confirmed. As a result, when the data of all the stripes 206 has not been confirmed (step S1805: NO), the MP 115 advances the processing to step S1802. On the other hand, when the data of all the stripes 206 of the parcel 205 has been confirmed (step S1805: YES), the MP 115 advances the processing to step S1806.

In step S1806, the MP 115 determines whether or not stripe data elements of all the stripes 206 of the parcel 205 have been restored.

As a result, when the stripe data elements of all the stripes 206 have not been restored (step S1806: NO), the MP 115 updates the parcel state 606 of the parcel including the stripes 206 for which restoration has been completed in the parcel mapping table 1601, from “restoration necessity” to “parity part restoration necessity”, and advances the processing to step S1801. On the other hand, when the stripe data elements of all the stripes of the parcel have been restored (step S1806: YES), the MP 115 updates the parcel state 606 of the parcel 205 including the stripes 206 for which restoration has been completed in the parcel mapping table 1601, from “restoration necessity” to “blank (restoration unnecessity)” (step S1808), and advances the processing to step S1801.

In the data restoration processing of step S1803, an example is shown in which the data restoration processing is performed on only the stripe data element of the data part failed. However, a stripe data element of a parity part failed in the same stripe row as the stripe data element of the data part failed may be restored together. If only the stripe data element of the data part failed is targeted, efficiency of the restoration processing of the entire data part in the upper storage device 101 can be improved. Meanwhile, if the stripe data element of the parity part of the same stripe row is restored together, a processing time required to restore the stripe element of the parity part can be shortened.

Next, the parity part rebuilding processing (S1706) will be described in detail.

FIG. 19 is a flowchart showing an example of the parity part rebuilding processing according to the third embodiment.

In the parity part rebuilding processing, the MP 115 executes (controls) the rebuilding processing at low speed, according to setting of the rebuilding processing. The MP 115 refers to the parcel mapping table 1601 and determines whether or not there is a parcel 205 for which rebuilding is not completed in the extent 204 of the processing target, that is, whether or not there is a parcel 205 of which the parcel state is “parity part restoration necessity” (step S1901). As a result, when there is no parcel 205 for which rebuilding is not completed (step S1901: NO), the MP 115 ends the parity part rebuilding processing.

On the other hand, when there is the parcel 205 for which rebuilding is not completed (step S1901: YES), the MP 115 determines whether or not data (stripe data element) of one stripe of one parcel for which rebuilding is not completed is “restoration necessity” (step S1902). Whether or not the stripe data element is “restoration necessity” can be determined by determining whether or not the stripe state 1603 corresponding to the stripe number of the processing target is “restoration necessity”, with reference to the parcel mapping table 1601.

As a result, when restoration of the stripe data element is necessary (step S1902: YES), the MP 115 executes the data restoration processing (refer to FIG. 12) on the parcel 205 of the processing target (step S1903). After the data restoration processing is completed, the MP 115 updates the stripe state 1603 of the entry corresponding to the stripe 206 for which restoration has been completed in the parcel mapping table 1601, from “restoration necessity” to “blank (restoration unnecessity)” (step S1904), and advances the processing to step S1905.

On the other hand, when restoration of the stripe data element is not necessary (step S1902: NO), the MP 115 advances the processing to step S1905.

In step S1905, the MP 115 determines whether or not data of all the stripes 206 of the parcel 205 has been confirmed. As a result, when the data of all the stripes 206 has not been confirmed (step S1905: NO), the MP 115 advances the processing to step S1902. On the other hand, when the data of all the stripes 206 of the parcel 205 has been confirmed (step S1905: YES), the MP 115 advances the processing to step S1906.

In step S1906, the MP 115 updates the parcel state 606 of the parcel 205 including the stripe 206 for which restoration has been completed in the parcel mapping table 1601, from “restoration necessity” to “blank (restoration unnecessity)”, and advances the processing to step S1901.

As described above, in the third embodiment, by performing the rebuilding processing at high speed with the higher priority given to the data part read from the host 103 than the parity part not read from the host 103, it is possible to shorten a generation time of collection read, and by performing the low-speed rebuilding processing on the parity part, it is possible to suppress degradation of I/O performance of the host 103 during the same period.

### Fourth Embodiment

Next, a computer system according to a fourth embodiment will be described.

The fourth embodiment is an embodiment in which the number of parcels to be restored at the time of high-speed rebuilding processing (first rebuilding processing) to be executed first is set to less than the number of failed parcels in an extent 204, a plurality of extents 204 are processed in parallel, and lower storage devices 121 of the restoration destination of the extents 204 to be rebuilt in parallel are distributed to a plurality of lower storage devices 121, so that a decrease period of a data redundancy is shortened, and then relative low-speed rebuilding processing (second rebuilding processing) is executed, so that it is possible to suppress degradation of I/O performance of a host 103 during the same period, in the first embodiment. An amount of data restored by the first rebuilding processing and written to the lower storage device 121 is reduced and writing is performed in parallel with respect to the plurality of lower storage devices 121, so that a time required to complete the first rebuilding processing that degrades I/O performance of the host can be shortened. The description of portions common to the first embodiment will be omitted.

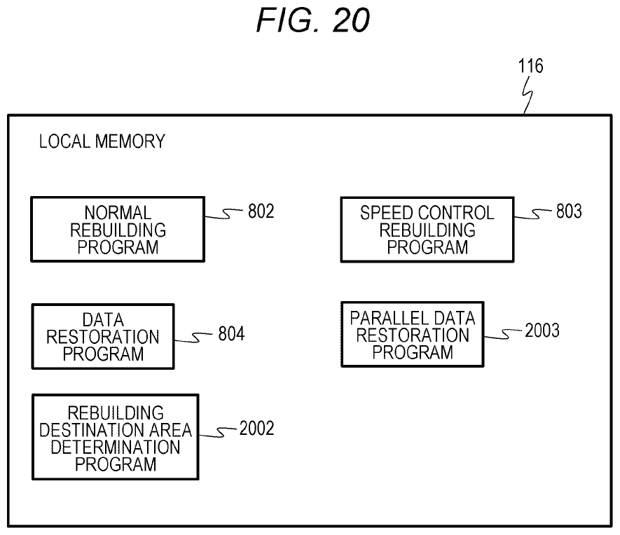

FIG. 20 is a configuration diagram of a local memory according to the fourth embodiment.

A local memory 116 stores a normal rebuilding program 802, a speed control rebuilding program 803, a data restoration program 804, a parallel data restoration program 2003, and a rebuilding destination area determination program 2002.

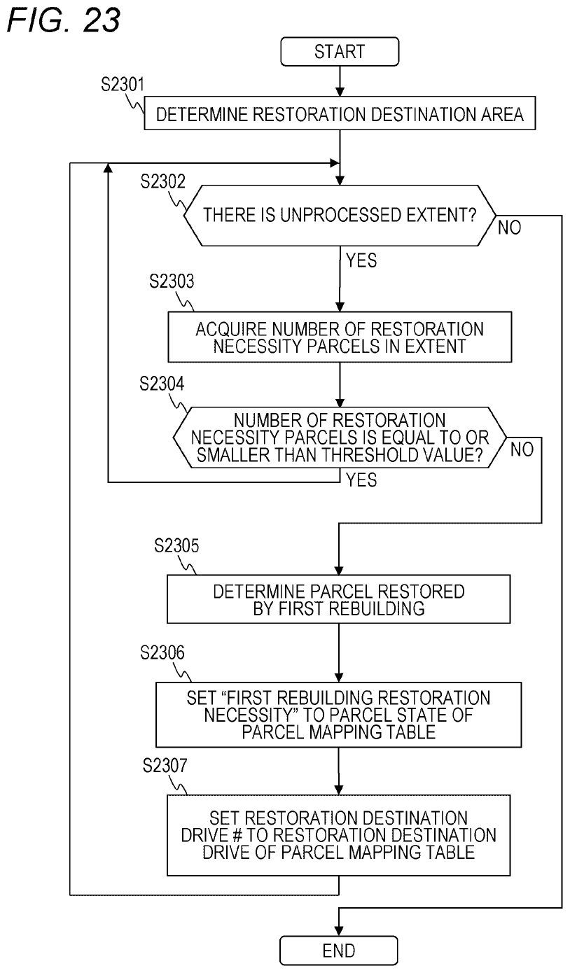

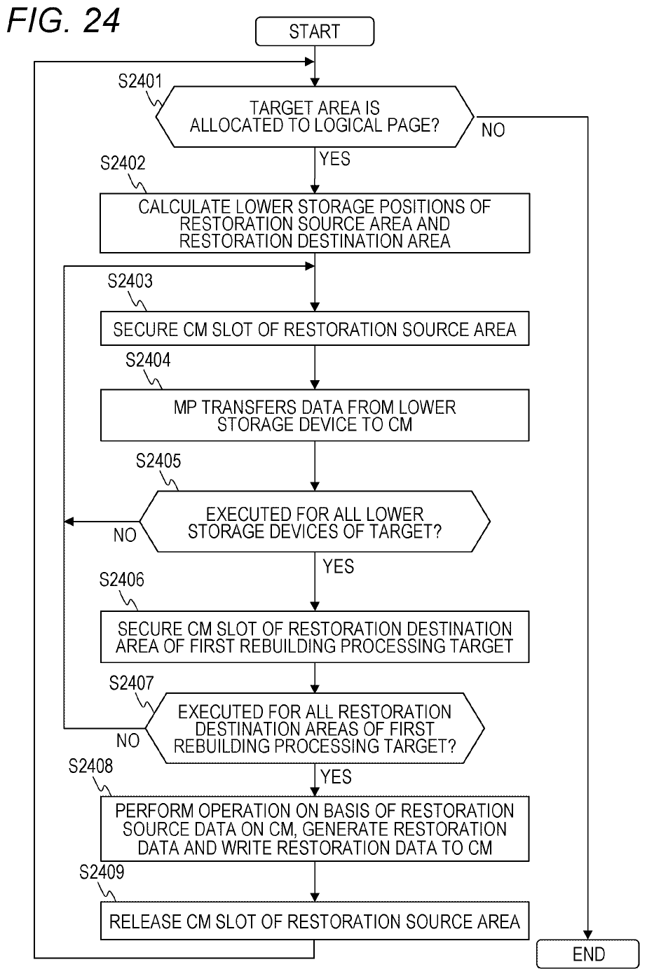

The rebuilding destination area determination program 2002 is a program for causing an MP 115 to execute rebuilding destination area determination processing (refer to FIG. 23). The parallel data restoration program 2003 is a program for causing the MP 115 to execute parallel data restoration processing (refer to FIG. 24).

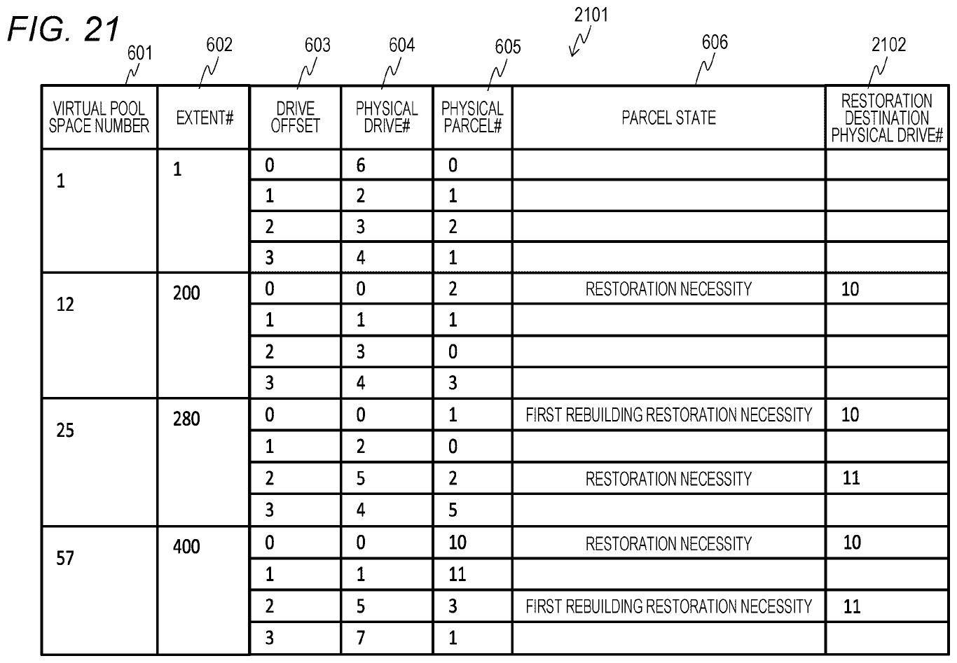

FIG. 21 is a diagram showing an example of a parcel mapping table 2101 according to the fourth embodiment.

The parcel mapping table 2101 manages entries including fields of a virtual pool space number 601, an extent number (#) 602, a drive offset 603, a physical drive number (#) 604, a physical parcel number (#) 605, a parcel state 606, and a restoration destination physical drive number (#) 2102.

The parcel state 606 stores a state of the parcel 205 corresponding to the physical parcel number of the physical parcel # 605 in the entry. In the present embodiment, in the parcel state 606, “restoration necessity” is set to the case where restoration is necessary for a data element stored in the parcel 205, “first rebuilding restoration necessity” is set to the case where it is determined that restoration in the first rebuilding processing (refer to FIG. 24) is necessary as a result of executing the rebuilding destination area determination processing by the MP 115, and a blank is set to the other cases. For example, when the lower storage device 121 is in a failure state, the MP 115 sets “restoration necessity” to the parcel state 606 of the entry corresponding to the parcel 205 of the lower storage device 121.

The restoration destination physical drive (#) 2102 stores a number of a physical drive (physical drive number) including the restoration destination parcel 205 in which the parcel of which the parcel state indicated by the parcel state 606 is “restoration necessity” or “first rebuilding restoration necessity” is restored by rebuilding processing.

Next, speed control rebuilding processing according to the fourth embodiment will be described.

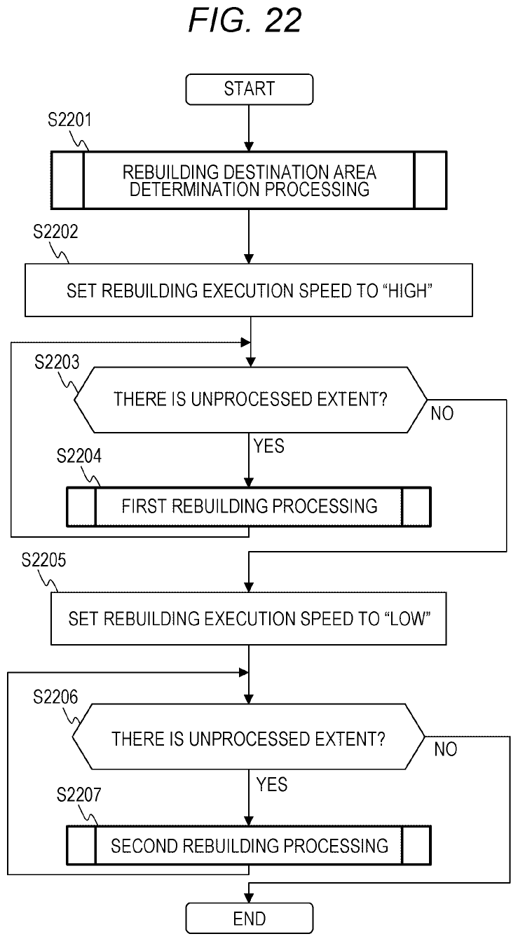

FIG. 22 is a flowchart showing an example of the speed control rebuilding processing according to the fourth embodiment.

The MP 115 first executes the rebuilding destination area determination processing (refer to FIG. 23) (step S2201). In the rebuilding destination area determination processing, for the extent 204 including the parcel 205 of which the parcel state is “restoration necessity”, the parcel 205 to be restored by the first rebuilding processing and the lower storage device 121 of the restoration destination are determined.

Next, the MP 115 sets a rebuilding execution speed to “high” (S2202). Next, the MP 115 determines whether or not there is an extent 204 for which the first rebuilding processing (S2204) is not executed (step S2203).

As a result, when there is the extent 204 for which the first rebuilding processing is not executed (step S2203: YES), the MP 115 sets one extent 204 among the extents 204 for which the first rebuilding processing is not executed as a processing target, executes the first rebuilding processing (refer to FIG. 24) on the processing target (step S2204), and advances the processing to step S2203. All the parcels 205 configuring the extent 204 for which the first rebuilding processing has been completed are in a state of “blank (restoration unnecessity)”.

On the other hand, when there is no extent 204 for which the first rebuilding processing is not executed (step S2203: NO), the MP 115 sets the rebuilding execution speed to “low” (step S2205).

Next, the MP 115 determines whether or not there is an extent 204 for which the second rebuilding processing (S2207) is not executed (step S2206).

As a result, when there is the extent 204 for which the second rebuilding processing is not executed (step S2206: YES), the MP 115 sets one extent 204 among the extents 204 for which the second rebuilding processing is not executed as a processing target, executes the second rebuilding processing (similar to normal rebuilding processing of FIG. 13) on the processing target (step S2207), and advances the processing to step S2206.

On the other hand, when there is no extent 204 on which the second rebuilding processing is not executed (step S2206: NO), the MP 115 ends the speed control rebuilding processing.

Next, the rebuilding destination area determination processing (S2201) will be described in detail.

FIG. 23 is a flowchart showing an example of the rebuilding destination area determination processing according to the fourth embodiment.

The MP 115 first determines the restoration destination area for the parcel 205 in a state of “restoration necessity”, and stores a physical drive number of the determined area in the restoration destination drive number 2102 of the parcel mapping table 2101 (step S2301). The restoration destination area is selected from the lower storage devices 121 other than the lower storage device 121 to which the parcel 205 included in the extent 204 including the parcel 205 of “restoration necessity” belongs, for data protection. In the present embodiment, an example of using the lower storage device 121 preset in a drive unit as a spare device in an upper storage device 101 with respect to the failed lower storage device 121 is described. However, the restoration destination may be set for each parcel 205.

Next, the MP 115 determines whether or not there is an unprocessed extent 204 (step S2302). As a result, when there is no unprocessed extent 204 (step S2302: NO), the MP 115 ends the rebuilding destination area determination processing.

On the other hand, when there is the unprocessed extent 204 (step S2302: YES), the MP 115 sets one extent 204 among the unprocessed extents 204 as a processing target and acquires the number of parcels in a state of “restoration necessity” in the extent 204 (step S2303). The number of parcels in a state of “restoration necessity” can be acquired by referring to the parcel mapping table 2101 and specifying the number of parcels of which the parcel state 606 of the entry indicated by the extent # of the target extent 204 is “restoration necessity”.

Next, the MP 115 determines whether the specified number of parcels in a state of “restoration necessity” is equal to or less than a predetermined threshold value (S2304). The threshold value used in the determination may be determined may be determined by, for example, a redundancy (decrease redundancy) capable of being decreased, which is allowed for maintaining data reliability. For example, when the lower storage device 121 is redundantly configured by three parity, the data redundancy is 3. At this time, assuming that a redundancy of 2 or more is required to maintain reliability, the number of parcels in a state of “restoration necessity” that are allowed for the extent is 3−2=1, and the threshold value may be set to “1”.

As a result, when the specified number of parcels in a state of “restoration necessity” is equal to or less than the predetermined threshold value (S2304: YES), the parcels of the extent 204 are not targets of the first rebuilding processing, so that the MP 115 advances the processing to step S2302.

On the other hand, when the specified number of parcels in a state of “restoration necessity” exceeds the predetermined threshold value (S2304: NO), the MP 115 determines the parcel 205 to be restored in the first rebuilding processing and the drive If of the restoration destination (step S2305). In step S2305, the MP 115 selects, from the parcels 205 in a state of “restoration necessity” in the extent 204, the parcels 205 corresponding to (the number of parcels in a state of “restoration necessity”−“the threshold value”) as the parcels 205 to be restored. At the time of the parcel selection, the physical drive to be the restoration destination of the parcels 205 selects the parcels 205 to be distributed to each extent 204. As a result, the restoration destination area is distributed to the plurality of lower storage devices 121, and an I/O load of writing at the time of restoration is distributed. The physical drive of the restoration destination can be specified by referring to the restoration destination drive number entry 2102 of the parcel mapping table 2101.

Next, the MP 115 sets “first rebuilding restoration necessity” to the parcel state 606 of the entry of the parcel mapping table 2101 corresponding to the parcel 205 selected as the restoration target (S2306), sets the determined restoration destination drive # to the restoration destination physical drive 2102 of the entry (step S2307), and advances the processing to step S2302.

Next, the first rebuilding processing (S2204) will be described.

In the first rebuilding processing, the MP 115 executes (controls) the rebuilding processing at high speed, according to setting of the rebuilding processing. The first rebuilding processing is processing in which the parallel data restoration processing (refer to FIG. 24) is executed instead of the data restoration processing (step S1102: FIG. 12), in the rebuilding processing of the first embodiment shown in FIG. 11. Since the other steps are the same as those in the rebuilding processing shown in FIG. 11, the description is omitted.

Next, the parallel data restoration processing executed in the first rebuilding processing will be described.

FIG. 24 is a flowchart showing an example of the parallel data restoration processing according to the fourth embodiment.

In the parallel data restoration processing, restoration of a plurality of data may be executed in parallel by the MP 115. The MP 115 determines whether or not the stripe 206 of the parcel 205 of the restoration target to be the area of the restoration target is allocated to a logical page (step S2401). Here, whether or not the stripe 206 of the parcel 205 of the restoration target is allocated to the logical page can be grasped by specifying the virtual pool space number corresponding to the stripe 206 of the parcel 205 of the restoration target, the extent number, and the drive offset # with reference to the parcel mapping table 2101, specifying the physical page number on the basis of the extent number and the drive offset #, and specifying whether or not the logical page number is associated with the specified physical page number with reference to the page mapping table 402.

As a result, when the stripe 206 of the parcel 205 of the restoration target is not allocated to the logical page (step S2401: NO), the MP 115 ends the parallel data restoration processing.

On the other hand, when the stripe 206 of the parcel 205 of the restoration target is allocated to the logical page (step S2401: YES), the MP 115 calculates, from the parcel mapping table 2101, the lower storage device 121 storing the restoration source area, the lower storage device 121 storing the restoration destination area, and the positions of the restoration source area and the restoration destination area in the lower storage devices 121 (step S2402).

Next, the MP 115 sets one parcel 205 of the restoration target as a processing target, secures a cache slot for storing data of the restoration source area in the CM 113, and acquires a lock of the secured cache slot (step S2403). Next, the MP 115 transfers data elements and/or parity of the restoration source area from the lower storage device 121 of the restoration source area to the cache slot of which the lock has been acquired via the transfer buffer 110 (step S2404).

Next, the MP 115 determines whether or not the data elements and/or the parity of the restoration source areas have been transferred from the lower storage devices 121 of all restoration source areas to the parcel 205 of the processing target (step S2405). When the data elements and/or the parity of the restoration source areas have not been transferred from the lower storage devices 121 of all the restoration source areas (step S2405: NO), the MP 115 advances the processing to step S2403 and performs the processing for another parcel 205 not to be the processing target. Meanwhile, when the data elements and/or the parity of the restoration source areas have been transferred from the lower storage devices 121 of all the restoration source areas (step S2405: YES), the MP 115 advances the processing to step S2406.

In step S2406, the MP 115 secures, in the CM 113, a cache slot for storing data to be restored.

Next, the MP 115 determines whether or not the cache slots of all the restoration destination areas to be the targets of the first rebuilding processing have been secured (step S2407). Here, whether or not the restoration destination area is the restoration destination area to be the target of the first rebuilding processing can be determined by determining whether or not the parcel state 606 of the parcel 205 storing the data element stored in the cache slot is “first rebuilding restoration necessity”, in the parcel mapping table 2101.

As a result, when the cache slots of all the restoration destination areas of the first rebuilding processing have not been secured (step S2407: NO), the MP 115 advances the processing to step S2403, and executes processing of securing a cache slot of the restoration destination area of the first rebuilding processing target not to be the processing target.

On the other hand, when the cache slots of all the restoration destination areas of the first rebuilding processing targets have been secured (step S2407: YES), the MP 115 generates restoration data by executing operation processing to restore data, on the basis of the data (data elements and parity data) of the plurality of restoration source areas on the CM 113, and stores the restoration data in the cache slot of the CM 113 (step S2408). The restoration data is stored in the lower storage device 121 by performing processing of writing the data stored in the CM 113 to the lower storage device 121 by the MP 115 thereafter.

Next, the MP 115 releases the cache slot of the CM 113 storing the data of the restoration source area (step S2409), and advances the processing to step S2401.

### Fifth Embodiment

Next, a computer system according to a fifth embodiment will be described.

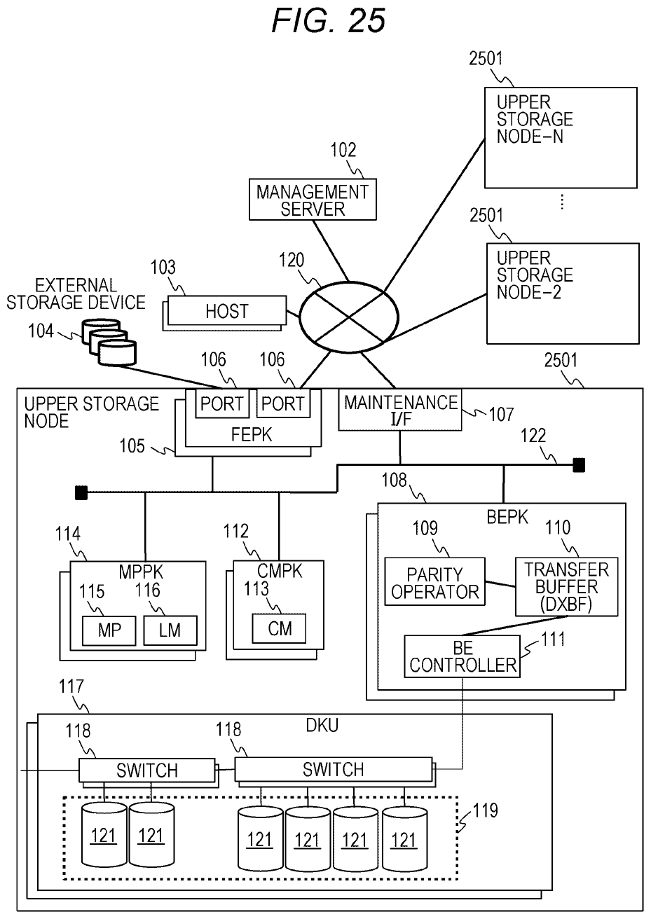

FIG. 25 is a hardware configuration diagram of the computer system according to the fifth embodiment.

In the computer system according to the fifth embodiment, a plurality of upper storage nodes (an example of a storage system) 2501 are connected to a network 120 and can mutually communicate data. Further, a host 103 is connected to the network 120.

In the storage system according to the first embodiment, an example is shown in which a RAID group is configured between lower storage devices 121 connected to a single upper storage device 101. However, in the fifth embodiment, the RAID group is configured between the lower storage devices 121 connected to the plurality of upper storage nodes 2501.

In such a configuration, if rebuilding processing is executed due to a failure of the lower storage device 121, there is a possibility that a band of the network 120 may be consumed by data used for rebuilding and the communication throughput between the host 103 and the upper storage node 2501 may be reduced. In the present embodiment, after a data redundancy is sufficiently recovered by controlling a speed of the rebuilding processing using the technology described in any one of the first to fourth embodiments, the network band that can be used by the host 103 can be secured by reducing the speed of the rebuilding processing.

The present invention is not limited to the above-described embodiments, and can be appropriately modified and implemented without departing from the spirit of the present invention.

For example, in any embodiment described above, during the execution of the speed control rebuilding processing with setting of the rebuilding speed (for example, FIGS. 9, 15, 17, and 22), the speed control rebuilding processing that is being executed may be ended, and the speed control rebuilding processing may be executed again. For example, even during the execution of the speed control rebuilding processing, a new failure of the lower storage device 121 or the like may occur, and the rebuilding speed determined in the speed control rebuilding processing that is being executed may not be suitable for a situation of the storage system at that time. Therefore, rebuilding can be performed at an appropriate speed by executing the speed control rebuilding processing again as described above.

Specifically, for example, in the first embodiment, when there is a change in classification in which the extent classification processing shown in FIG. 10 is executed and the setting of the rebuilding processing speed in the speed control rebuilding processing being executed should be changed, the speed control rebuilding processing may be executed again. Further, in the second embodiment, the speed control rebuilding processing may be executed again when it is detected that a failure of the lower storage device 121 has newly occurred at the time of executing the speed control rebuilding processing shown in FIG. 15.

What is claimed is:

1. A storage system comprising:
an interface that is connected to a plurality of storage devices; and
a control unit that is connected to the interface,
wherein each of the plurality of storage devices has a plurality of stripes configuring a plurality of stripe rows,
each of the plurality of stripe rows is a row of two or more stripes which two or more storage devices have, respectively,
when each of the plurality of stripe rows stores a plurality of data elements and at least one redundant code and a predetermined allowable number of storage devices fail, the data elements in the stripes of the failed storage devices are restored,
the number of storage devices is more than the number of stripes configuring one stripe row, and
the control unit controls a processing speed in restoration processing of failed stripes to be the stripes in the failed storage devices, on the basis of restoration priorities for the data elements or the redundant code of the failed stripes.

2. The storage system according to claim 1,
wherein, when the number of failed stripes included in the stripe row is equal to or more than a predetermined threshold value, the control unit determines that the restoration priority of the stripe row is high, when the number of failed stripes is less than the predetermined threshold value, the control unit determines that the restoration priority of the stripe row is low, and
the control unit performs control so that restoration processing of the stripe row determined to have the high restoration priority is executed before restoration processing of the failed stripe row determined to have the low restoration priority and a processing speed in the restoration processing of the failed stripe row determined to have the low restoration priority is lower than a processing speed in the restoration processing of the stripe row determined to have the high restoration priority.

3. The storage system according to claim 1,
wherein the control unit determines the restoration priority of the stripe row, on the basis of the number of failed storage devices in a plurality of storage devices storing a plurality of the stripe rows, and
the control unit controls a processing speed in restoration processing of the failed stripe row, on the basis of the determined restoration priority of the stripe row.

4. The storage system according to claim 1,
wherein the control unit determines that the restoration priority of the failed stripe storing the data elements is higher than the restoration priority of the failed stripe storing the redundant code, and
the control unit performs control so that restoration processing of the failed stripe storing the data elements is executed before restoration processing of the failed stripe storing the redundant code and a processing speed in the restoration processing of the failed stripe storing the redundant code is lower than a processing speed in the restoration processing of the failed stripe storing the data elements.

5. The storage system according to claim 4,
wherein, when the restoration processing of the failed stripe storing the data elements is executed, the control unit executes restoration processing for a failed stripe storing a parity part belonging to the same stripe row as the failed stripe together.

6. The storage system according to claim 1,
wherein the control unit determines that the restoration priority of the failed stripes corresponding to a number exceeding a predetermined threshold value among the failed stripes included in the stripe row is higher than the restoration priority of the other failed stripes, and
the control unit performs control so that restoration processing of the failed stripes corresponding to the number exceeding the predetermined threshold value among the failed stripes included in the stripe row is executed before restoration processing of the other failed stripes and a processing speed in the restoration processing of the other failed stripes is lower than a processing speed in the restoration processing of the failed stripes corresponding to the number exceeding the predetermined threshold value among the failed stripes included in the stripe row.

7. The storage system according to claim 6,
wherein the predetermined threshold value is a redundancy reduced from the allowable number to be allowed for maintaining reliability of data of the stripe row.

8. The storage system according to claim 2,
wherein, when the restoration processing of the failed stripe is executed according to the restoration priority of the failed stripe at a predetermined time point,
the control unit stops the execution of the restoration processing of the failed stripe, and newly executes the restoration processing of the failed stripe, according to the determination of the restoration priority of the failed stripe at a time point later than the predetermined time point.

9. The storage system according to claim 1,
wherein the control unit adjusts an allowable value of a ratio of I/O of the restoration processing of the failed stripe with respect to I/O from a host computer, an execution priority in the control unit for the restoration processing of the failed stripe, or an amount of resources allocated to the restoration processing of the failed stripe, and controls the processing speed in the restoration processing of the failed stripe.

10. A data management method in a storage system having an interface connected to a plurality of storage devices and a control unit connected to the interface,
wherein each of the plurality of storage devices has a plurality of stripes configuring a plurality of stripe rows, each of the plurality of stripe rows is a row of two or more stripes which two or more storage devices have, respectively,
when each of the plurality of stripe rows stores a plurality of data elements and at least one redundant code and a predetermined allowable number of storage devices fail, the data elements in the stripes of the failed storage devices are restored,
the number of storage devices is more than the number of stripes configuring one stripe row, and
the storage system controls a processing speed in restoration processing of failed stripes to be the stripes in the failed storage devices, on the basis of restoration priorities of the data elements or the redundant code of the failed stripes.

11. A data management program executed by a computer configuring a storage system having an interface connected to a plurality of storage devices and a control unit connected to the interface,
wherein each of the plurality of storage devices has a plurality of stripes configuring a plurality of stripe rows,
each of the plurality of stripe rows is a row of two or more stripes which two or more storage devices have, respectively,
when each of the plurality of stripe rows stores a plurality of data elements and at least one redundant code and a predetermined allowable number of storage devices fail, the data elements in the stripes of the failed storage devices are restored,
the number of storage devices is more than the number of stripes configuring one stripe row, and
the data management program causes the computer to control a processing speed in restoration processing of failed stripes to be the stripes in the failed storage devices, on the basis of restoration priorities of the data elements or the redundant code of the failed stripes.
